(19) United States
(12) Patent Application Publication
(10) Pub. No.: US 2025/0140470 A1
(43) Pub. Date: May 1, 2025

(54) COUPLED INDUCTOR, INDUCTOR UNIT, VOLTAGE CONVERTER, AND POWER CONVERSION DEVICE

(71) Applicant: Panasonic Intellectual Property Management Co., Ltd., Osaka (JP)

(72) Inventors: Hong-An SHIH, Kyoto (JP); Kenichi ASANUMA, Osaka (JP); Koji TAKAHASHI, Kanagawa (JP)

(21) Appl. No.: 18/834,498

(22) PCT Filed: Dec. 15, 2022
(86) PCT No.: PCT/JP2022/046194

§ 371 Date: Jul. 30, 2024

(30) Foreign Application Priority Data
Mar. 29, 2022 (JP) 2022-054347

(51) Int. Cl. H01F 27/29; H01F 3/08; H01F 5/04; H02M 3/155

(52) U.S. Cl. CPC H01F 27/292; H01F 5/04; H02M 3/155; H01F 3/08

(57) ABSTRACT

A coupled inductor includes: a magnetic body; a first conductor provided at least partially inside the magnetic body; and a second conductor provided at least partially inside the magnetic body and coupled to the first conductor. The magnetic body includes: a first surface and a second surface facing away from each other; and a third surface and a fourth surface facing away from each other and orthogonal to the first surface and the second surface. The first conductor includes: a first terminal provided at the first surface; and a second terminal provided at the second surface. The second conductor includes: a third terminal provided at the third surface; and a fourth terminal provided at the fourth surface.

### CROSS-REFERENCE OF RELATED APPLICATIONS

This application is the U.S. National Phase under 35 U.S.C. § 371 of International Patent Application No. PCT/JP2022/046194, filed on Dec. 15, 2022, which in turn claims the benefit of Japanese Patent Application No. 2022-054347, filed on Mar. 29, 2022, the entire disclosure of which Applications are incorporated by reference herein.

### TECHNICAL FIELD

The present disclosure relates to a coupled inductor, an inductor unit, a voltage converter, and a power conversion device.

### BACKGROUND ART

Patent Literature (PTL) 1 discloses a variable coupled inductor that includes a core and two conductive wires. The two conducting wires are drawn onto the same surface of the core.

### CITATION LIST

### Patent Literature

[PTL 1] US Patent Application Publication No. 2014/0055226

### SUMMARY OF INVENTION

### Technical Problem

In the above variable coupled inductor, the wiring length is increased when it is assumed that multiple phases are provided. Accordingly, this may cause deterioration of electrical properties, such as an increase in loss caused by electrical resistance of the wires, the occurrence of ringing caused by parasitic inductance, and a decrease in load responsiveness.

In view of this, the present disclosure provides, for instance, a coupled inductor that can reduce deterioration of electrical properties when multiple phases are provided.

### Solution to Problem

A coupled inductor according to one aspect of the present disclosure includes: a magnetic body; a first conductor provided at least partially inside the magnetic body; and a second conductor provided at least partially inside the magnetic body, the second conductor being coupled to the first conductor. The magnetic body includes: a first surface and a second surface facing away from each other; and a third surface and a fourth surface facing away from each other and orthogonal to the first surface and the second surface. The first conductor includes: a first terminal provided at the first surface; and a second terminal provided at the second surface. The second conductor includes: a third terminal provided at the third surface; and a fourth terminal provided at the fourth surface.

A coupled inductor according to another aspect of the present disclosure includes: a magnetic body; a first conductor provided at least partially inside the magnetic body; and a second conductor provided at least partially inside the magnetic body, the second conductor being coupled to the first conductor. The magnetic body includes: a first surface and a second surface facing away from each other; and a third surface and a fourth surface facing away from each other and orthogonal to the first surface and the second surface. The first conductor includes: a first terminal and a second terminal provided at the fourth surface. The second conductor includes: a third terminal provided at the second surface; and a fourth terminal provided at the first surface.

A coupled inductor according to another aspect of the present disclosure includes: a magnetic body; a first conductor provided at least partially inside the magnetic body; and a second conductor provided at least partially inside the magnetic body, the second conductor being coupled to the first conductor. The magnetic body includes: a third surface and a fourth surface facing away from each other; and a fifth surface and a sixth surface facing away from each other and orthogonal to the third surface and the fourth surface. The fifth surface faces a substrate on which the coupled inductor is to be mounted. The first conductor includes: a first terminal provided at the sixth surface; and a second terminal provided at the fifth surface. The second conductor includes: a third terminal provided at the third surface; and a fourth terminal provided at the fourth surface.

An inductor unit according to one aspect of the present disclosure includes: a first coupled inductor that is the coupled inductor according to the above one aspect; and a second coupled inductor facing the fourth surface of the first coupled inductor. The second coupled inductor has a mirror-inverted structure of a structure of the first coupled inductor.

A voltage converter according to one aspect of the present disclosure includes: the coupled inductor according to the above one aspect; a switching element; an input capacitor element; and an output capacitor element. At least one of the input capacitor element or the switching element faces the sixth surface, and the output capacitor element faces the fifth surface.

A voltage converter according to another aspect of the present disclosure includes the coupled inductor according to the above one aspect.

A power conversion device according to one aspect includes the voltage converter according to the one aspect.

### Advantageous Effects of Invention

According to the present disclosure, deterioration of electrical properties when multiple phases are provided can be reduced.

### BRIEF DESCRIPTION OF DRAWINGS

FIG. 1 is a circuit diagram illustrating a circuit configuration of a voltage converter according to an embodiment.

FIG. 2A is a schematic diagram illustrating an example of a configuration of the voltage converter that adopts a hybrid power feeding method.

FIG. 2B is a diagram for describing a method of feeding power by the voltage converter illustrated in FIG. 2A.

FIG. 3A is a schematic diagram illustrating another example of a configuration of the voltage converter that adopts the hybrid power feeding method.

FIG. 3B is a diagram for describing a method of feeding power by the voltage converter illustrated in FIG. 3A.

FIG. 4 includes a plan view and a front view of a coupled inductor according to Example 1.

FIG. 5 is a plan view illustrating a configuration of an inductor unit that includes plural coupled inductors each as illustrated in FIG. 4.

FIG. 6 includes a plan view and a front view of a coupled inductor according to Example 2.

FIG. 7 is a plan view illustrating a configuration of an inductor unit that includes plural coupled inductors each as illustrated in FIG. 6.

FIG. 8 is a plan view illustrating a configuration of an inductor unit according to Example 3.

FIG. 9 includes a plan view and a front view of a coupled inductor according to Example 4.

FIG. 10 is a plan view illustrating a configuration of an inductor unit that includes plural coupled inductors each as illustrated in FIG. 9.

FIG. 11A is a schematic diagram illustrating an example of a configuration of a voltage converter that adopts a vertical power feeding method.

FIG. 11B is a diagram for describing a method of feeding power by the voltage converter illustrated in FIG. 11A.

FIG. 12 includes a plan view and a front view of a coupled inductor according to Example 5.

FIG. 13 includes a plan view and a front view of a coupled inductor according to Example 6.

FIG. 14 is a plan view illustrating a configuration of an inductor unit includes plural coupled inductors each as illustrated in FIG. 13.

FIG. 15 is a plan view illustrating a configuration of an inductor unit according to Example 7.

FIG. 16 includes a plan view and a front view of a coupled inductor according to Example 8.

FIG. 17 is a plan view illustrating a configuration of an inductor unit that includes plural coupled inductors each as illustrated in FIG. 16.

FIG. 18 includes a plan view and a front view of a coupled inductor according to Example 9.

FIG. 19 includes a plan view and a front view of a coupled inductor according to Example 10.

FIG. 20 illustrates a configuration of a power conversion device according to the embodiment.

FIG. 21 is a perspective view of a coupled inductor according to a variation of the embodiment.

FIG. 22 shows plan views illustrating surfaces of a first magnetic body and a second magnetic body that are combined with each other.

FIG. 23 shows plan views illustrating states in which conductors are accommodated in the first magnetic body and the second magnetic body illustrated in FIG. 22, respectively.

FIG. 24 shows plan views illustrating variations of surfaces of the first magnetic body and the second magnetic body that are combined with each other.

FIG. 25 shows plan views illustrating states in which the conductors are accommodated in the first magnetic body and the second magnetic body illustrated in FIG. 24, respectively.

### DESCRIPTION OF EMBODIMENTS

### Summary of the Present Disclosure

A coupled inductor according to a first aspect of the present disclosure includes: a magnetic body; a first conductor provided at least partially inside the magnetic body; and a second conductor provided at least partially inside the magnetic body, the second conductor being coupled to the first conductor. The magnetic body includes: a first surface and a second surface facing away from each other; and a third surface and a fourth surface facing away from each other and orthogonal to the first surface and the second surface. The first conductor includes: a first terminal provided at the first surface; and a second terminal provided at the second surface. The second conductor includes: a third terminal provided at the third surface; and a fourth terminal provided at the fourth surface.

Accordingly, two terminals (for example, the first terminal and the second terminal) used to supply power to a load and in comparison thereto, two terminals (for example, the third terminal and the fourth terminal) used to connect a coupled line are disposed at different lateral surfaces. Accordingly, when the coupled inductors are provided in multiple phases, not only the terminals used to connect the coupled line can be made facing each other, but also the directions in which lines used to supply power extend can be caused to coincide with each other, and thus the wiring length can be shortened. Since the wiring length is shortened, loss can be decreased. Furthermore, the occurrence of ringing caused by parasitic inductance and a decrease in load responsiveness can be reduced. In this manner, according to the coupled inductor according to this aspect, deterioration of electrical properties when multiple phases are provided can be reduced.

For example, a coupled inductor according to a second aspect of the present disclosure is the coupled inductor according to the first aspect in which the first terminal may be provided in a position in the first surface closer to the third surface than to the fourth surface, the second terminal may be provided in a position in the second surface closer to the fourth surface than to the third surface, the third terminal may be provided in a position in the third surface closer to the first surface than to the second surface, and the fourth terminal may be provided in a position in the fourth surface closer to the second surface than to the first surface.

Accordingly, the first terminal of the first conductor and the third terminal of the second conductor can be disposed close to each other. The second terminal of the first conductor and the fourth terminal of the second conductor can be disposed close to each other. Accordingly, the length of parallel extending portions of the first conductor and the second conductor inside the magnetic body can be increased, and thus the coupling between the first conductor and the second conductor can be strengthened. Hence, since the coupling coefficient of the coupled inductor can be increased, leakage inductance can be decreased.

For example, a coupled inductor according to a third aspect of the present disclosure includes: a magnetic body; a first conductor provided at least partially inside the magnetic body; and a second conductor provided at least partially inside the magnetic body, the second conductor being coupled to the first conductor. The magnetic body includes: a first surface and a second surface facing away from each other; and a third surface and a fourth surface facing away from each other and orthogonal to the first surface and the second surface. The first conductor includes: a first terminal and a second terminal provided at the fourth surface. The second conductor includes: a third terminal provided at the second surface; and a fourth terminal provided at the first surface.

Accordingly, the first terminal and the second terminal of the first conductor that can be used to supply power can be disposed at the same lateral surface. Accordingly, for example, the coupled inductor can receive, using the first terminal, power supplied in the vertical direction, and supply power to a load through the second terminal. The coupled inductor according to this aspect is useful to a voltage converter that adopts a hybrid power feeding method (in the horizontal direction+the vertical direction).

For example, a coupled inductor according to a fourth aspect of the present disclosure is the coupled inductor according to the third aspect in which the fourth surface may be closer to a load than the third surface is, the load being configured to receive supply of a current flowing through the first conductor.

Accordingly, the distance between the coupled inductor and the load can be shortened, and thus the wiring length for supplying power can be shortened. Since the wiring length is shortened, loss can be decreased. Furthermore, the occurrence of ringing caused by parasitic inductance and a decrease in load responsiveness can be reduced. In this manner, according to the coupled inductor according to this aspect, deterioration of electrical properties when multiple phases are provided can be reduced.

For example, a coupled inductor according to a fifth aspect of the present disclosure includes: a magnetic body; a first conductor provided at least partially inside the magnetic body; and a second conductor provided at least partially inside the magnetic body, the second conductor being coupled to the first conductor. The magnetic body includes: a third surface and a fourth surface facing away from each other; and a fifth surface and a sixth surface facing away from each other and orthogonal to the third surface and the fourth surface. The fifth surface faces a substrate on which the coupled inductor is to be mounted. The first conductor includes: a first terminal provided at the sixth surface; and a second terminal provided at the fifth surface. The second conductor includes: a third terminal provided at the third surface; and a fourth terminal provided at the fourth surface.

Accordingly, the second terminal is provided at the fifth surface that faces the mounting surface of the substrate, and thus the wiring length when another element is stacked above the coupled inductor can be shortened. Since the wiring length is shortened, loss can be decreased. Furthermore, the occurrence of ringing caused by parasitic inductance and a decrease in load responsiveness can be reduced. In this manner, according to the coupled inductor according to this aspect, deterioration of electrical properties when multiple phases are provided can be reduced. Accordingly, the coupled inductor according to this aspect is useful to the voltage converter that adopts the vertical power feeding method.

For example, a coupled inductor according to a sixth aspect of the present disclosure is the coupled inductor according to the fifth aspect in which the third terminal may be provided continuously at the third surface and the sixth surface, and the fourth terminal may be provided continuously at the fourth surface and the fifth surface.

Accordingly, the third terminal of the second conductor used to connect the coupled line is disposed at the sixth surface, and thus can be disposed close to the first terminal of the first conductor used to supply power to the load. Similarly, the fourth terminal of the second conductor is disposed at the fifth surface, and thus can be disposed close to the second terminal of the first conductor. Accordingly, the length of parallel extending portions of the first conductor and the second conductor inside the magnetic body can be increased, and thus the coupling between the first conductor and the second conductor can be strengthened. Thus, the coupling coefficient of the coupled inductor can be increased, and thus leakage inductance can be decreased.

For example, a coupled inductor according to a seventh aspect of the present disclosure is the coupled inductor according to any one of the first aspect to the sixth aspect in which the first conductor may further include: a fifth terminal provided at a surface of the magnetic body that is same as a surface at which the third terminal is provided; and a sixth terminal provided at a surface of the magnetic body that is same as a surface at which the fourth terminal is provided, and the second conductor may further include: a seventh terminal provided at a surface of the magnetic body that is same as a surface at which the first terminal is provided; and an eighth terminal provided at a surface of the magnetic body that is same as a surface at which the second terminal is provided.

Accordingly, the auxiliary fifth to eighth terminals are provided for the first to fourth terminals, and thus the length of parallel extending portions of the first conductor and the second conductor inside the magnetic body can be increased. Accordingly, the coupling between the first conductor and the second conductor can be strengthened. Hence, the coupling coefficient of the coupled inductor can be increased, and thus leakage inductance can be reduced.

For example, a coupled inductor according to an eighth aspect of the present disclosure is the coupled inductor according to any one of the first to seventh aspects in which the first terminal may not protrude from the magnetic body in a view in a direction orthogonal to a surface at which the first terminal is provided, the second terminal may not protrude from the magnetic body in a view in a direction orthogonal to a surface at which the second terminal is provided, the third terminal may not protrude from the magnetic body in a view in a direction orthogonal to a surface at which the third terminal is provided, and the fourth terminal may not protrude from the magnetic body in a view in a direction orthogonal to a surface at which the fourth terminal is provided.

Accordingly, the terminals do not protrude from the lateral surfaces of the magnetic body, and thus the size of the coupled inductor can be reduced. Furthermore, mechanical shock is less likely to be directly applied to the terminals, and thus damage to the terminals can be reduced. Thus, a shock-resistant coupled inductor can be embodied.

An inductor unit according to a ninth aspect of the present disclosure includes: a first coupled inductor that is the coupled inductor according to the first aspect or the second aspect; and a second coupled inductor facing the fourth surface of the first coupled inductor. The second coupled inductor has a mirror-inverted structure of a structure of the first coupled inductor.

Accordingly, the wiring length of the coupled line can be further shortened. Thus, deterioration of electrical properties can be further reduced.

A voltage converter according to a tenth aspect of the present disclosure includes: the coupled inductor according to the fifth aspect or the sixth aspect; a switching element; an input capacitor element; and an output capacitor element. At least one of the input capacitor element or the switching element faces the sixth surface, and the output capacitor element faces the fifth surface.

Accordingly, elements can be stacked in the vertical direction, and, for example, a footprint necessary for mounting the elements can be reduced, and thus the size of the voltage converter can be reduced. For example, the wiring length can be shortened, and thus loss can be reduced. Furthermore, the occurrence of ringing caused by parasitic inductance and a decrease in load responsiveness can be reduced. Furthermore, the above coupled inductor is included, and thus deterioration of electrical properties can be reduced.

A voltage converter according to an eleventh aspect of the present disclosure includes: the coupled inductor according to any one of the first to eighth aspects or the inductor unit according to the ninth aspect.

Accordingly, the above-stated coupled inductor or inductor unit is included, and thus deterioration of electrical properties can be reduced.

The power conversion device according to a twelfth aspect of the present disclosure includes the voltage converter according to the tenth or eleventh aspect.

Accordingly, the above-stated voltage converter is included, and thus deterioration of electrical properties can be reduced.

The following specifically describes embodiments, with reference to the drawings.

Note that the embodiments described below each show a generic or specific example. The numerical values, shapes, materials, elements, the arrangement and connection of the elements, steps, the processing order of the steps, and others, for instance, described in the following embodiments are examples, and thus are not intended to limit the present disclosure. In addition, among the elements in the following embodiments, elements not recited in any independent claim are described as arbitrary elements.

In addition, the drawings are schematic diagrams, and do not necessarily provide strictly accurate illustration. Accordingly, scaling, for example, is not necessarily consistent throughout the drawings. In the drawings, the same numeral is given to substantially the same configuration, and a redundant description thereof is omitted or simplified.

In the Specification, a term that indicates a relation between elements such as parallel or perpendicular, a term that indicates the shape of an element such as rectangular parallelepiped or quadrilateral, and a numerical range do not necessarily have only strict meanings, but also have meanings that cover substantially equivalent ranges that include a difference of about several percent, for example.

In the Specification, the terms “above” and “below” do not indicate upward (vertically upward) or downward (vertically downward) in the absolute recognition of space, but are rather used as terms defined by a relative positional relation based on the stacking order in a stacked configuration. Furthermore, the terms “above” and “below” are applied not only when two elements are spaced apart from each other and another element is present therebetween, but also when two elements are in close contact with each other and touch each other.

In the Specification and the drawings, the x axis, the y axis, and the z axis represent three axes of a three-dimensional orthogonal coordinate system. In the embodiments, the z-axis direction is a direction perpendicular to a principal surface of a substrate on which an inductor is mounted.

### EMBODIMENT

### 1. Circuit Configuration of Voltage Converter

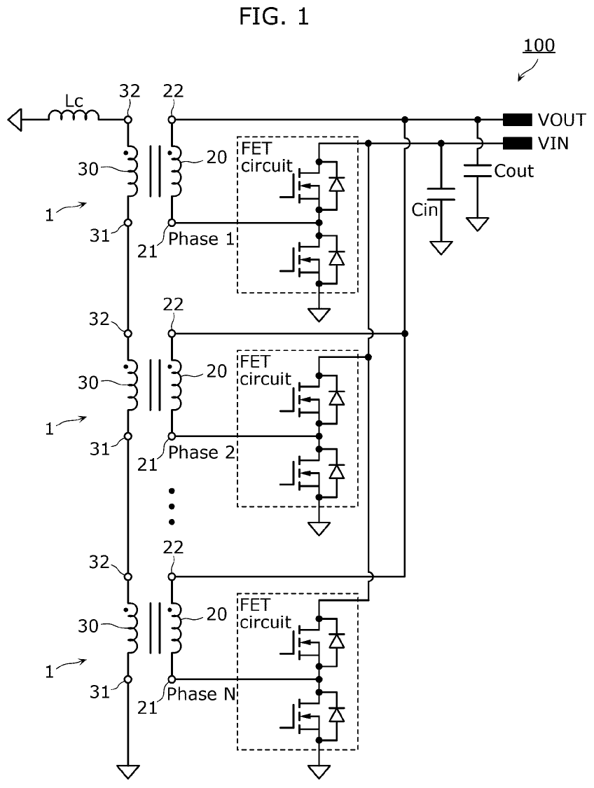

First, a circuit configuration of a voltage converter according to an embodiment is to be described with reference to FIG. 1. FIG. 1 is a circuit diagram illustrating a circuit configuration of voltage converter 100 according to the present embodiment.

Voltage converter 100 illustrated in FIG. 1 is used as a point of load (PoL) power supply. Specifically, voltage converter 100 is a step-down converter that supplies a predetermined voltage (current) to a load (a processor, for example).

As illustrated in FIG. 1, voltage converter 100 includes plural coupled inductors 1, plural field effect transistor (FET) circuits, input capacitor Cin, output capacitor Cout, inductor Lc, input terminal VIN, and output terminal VOUT. Coupled inductors 1 and the FET circuits are in one-to-one correspondence, and N coupled inductors 1 and N FET circuits are provided. Voltage converter 100 is an N-phase converter that can supply a stable voltage (current) by the N FET circuits sequentially operating. Note that N is a natural number of at least 2.

Input terminal VIN is a terminal for receiving power supply.

Output terminal VOUT is a terminal for outputting a voltage (current) generated by voltage converter 100. A load (not illustrated in FIG. 1) is connected to output terminal VOUT.

The load is an XPU, for example. An XPU is a processor such as a central processing unit (CPU), a graphics processing unit (GPU), or an application specific integrated circuit (ASIC), but is not limited in particular.

Input capacitor Cin is connected between the ground and a path that connects input terminal VIN and the FET circuits.

Output capacitor Cout is connected between the ground and a path that connects coupled inductors 1 and output terminal VOUT. Output capacitor Cout is also referred to as a bulk capacitor. Output capacitor Cout is provided to stabilize an amount of current supplied through output terminal VOUT.

The FET circuits are switching circuits each including two FETs. A diode is connected between a source and a drain in each of the two FETs. The diode is a so-called body diode (parasitic diode).

The two FETs are examples of switching elements, and on and off of the FETs are exclusively switched according to voltage application to gates made by a control circuit (not illustrated). Thus, the two FETs are controlled so as not to be on at the same time. Specifically, when one of the two FETs is on (in a conducting state), the other of the two FETs is off (in a non-conducting state). The two FETs are connected in series between input terminal VIN and the ground. By repeating on and off of the two FETs alternately, a current can be caused to flow from a connecting point of the two FETs to coupled inductor 1.

The N FET circuits from phase 1 to phase N sequentially operate in such a manner that their operation timings do not overlap. For example, an FET connected in series to a path that connects input terminal VIN and coupled inductor 1 is maintained on for a predetermined period, which is sequentially performed on FETs from phase 1 through phase N in this order. When this processing on the FETs in phase N ends, the processing is again repeatedly performed from phase 1. Accordingly, a current can be supplied to the load through output terminal VOUT.

Each coupled inductor 1 includes conductors 20 and 30 coupled to each other. Conductor 20 is a primary coil, and is connected between output terminal VOUT and the connecting point of the two FETs in an FET circuit. Conductor 30 is a secondary coil, and is connected in series to conductor 30 in another coupled inductor 1. One end of a series connected configuration of N conductors 30 is connected to the ground via inductor Lc, and another end thereof is directly connected to the ground. A line between the grounds in which N conductors 30 are disposed may be referred to as a coupled line.

A high current can be supplied to output capacitor Cout by N conductors 30 being connected in series. Thus, even when a high current is supplied through output terminal VOUT due to a load change, the high current can be supplied promptly. Thus, high-speed load responsiveness can be achieved.

Although details are described later, coupled inductors 1 according to the present embodiment can each exhibit a high coupling coefficient, and thus leakage inductance is decreased. Accordingly, greater latitude in designing inductor Lc is provided, so that the inductance value of inductor Lc is readily designed. Furthermore, since leakage inductance is decreased, load responsiveness is enhanced. Moreover, the wiring length for series connection of conductors 30 can be shortened, and thus not only loss can be decreased, but also ringing can be decreased, so that operation can be stabilized. Since the wiring length is shortened, parasitic inductance decreases, and thus load responsiveness is also enhanced.

### 2. Module Configuration of Voltage Converter (Hybrid Power Feeding Method)

Voltage converter 100 illustrated in FIG. 1 is mounted on a substrate together with the load and modularized. Voltage converter 100 can use a hybrid power feeding method and a vertical power feeding method, as power feeding methods for the load.

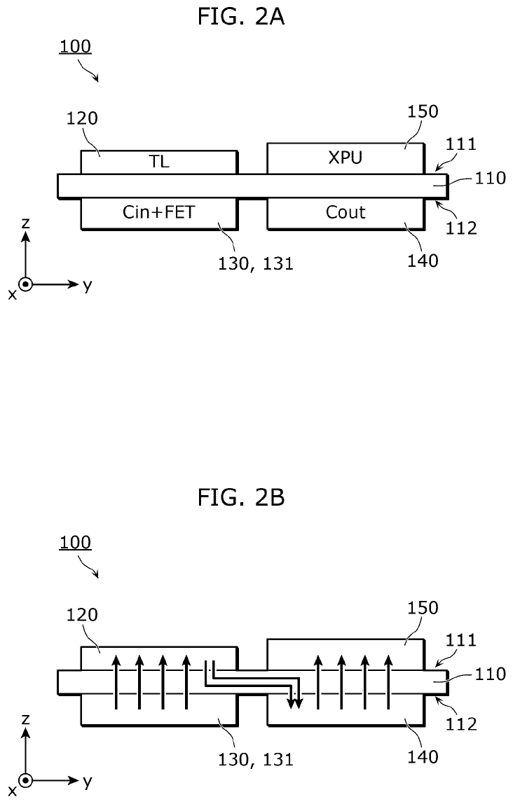

In the following, an example of a module configuration of voltage converter 100 that adopts a hybrid power feeding method is to be described first, with reference to FIG. 2A and FIG. 2B.

FIG. 2A is a schematic diagram illustrating an example of a configuration of voltage converter 100 that adopts a hybrid power feeding method. FIG. 2B is a diagram for describing a method of feeding power by voltage converter 100 illustrated in FIG. 2A.

As illustrated in FIG. 2A, voltage converter 100 is mounted on substrate 110. Substrate 110 is a printed circuit board (PCB), for example. Substrate 110 includes principal surfaces 111 and 112 facing away from each other. Although not illustrated, a conductive wiring layer and a conductive via for passing a current, for instance, are provided on and in principal surface 111 or 112 of substrate 110 or inside substrate 110.

Inductor unit 120 and XPU 150 that is an example of the load are disposed on principal surface 111. Chip capacitors 130 and 140 and integrated circuit 131 that includes the FET circuits are disposed on principal surface 112.

Inductor unit 120 includes plural coupled inductors 1. Specific arrangement of plural coupled inductors 1 is to be described later.

Chip capacitor 130 is an example of an input capacitor element, and embodies input capacitor Cin. Plural chip capacitors 130 may embody input capacitor Cin.

Integrated circuit 131 includes the plural FET circuits. The plural FET circuits may be distributed to and disposed in plural integrated circuits 131.

Chip capacitor 130 and integrated circuit 131 that includes the FET circuits are disposed in positions that overlap inductor unit 120 in a plan view of substrate 110.

Chip capacitor 140 is an example of an output capacitor element, and embodies output capacitor Cout. Plural chip capacitors 140 may embody output capacitor Cout. Chip capacitor 140 is disposed in a position that overlaps XPU 150 in a plan view of substrate 110.

FIG. 2B shows directions of currents with arrows. As illustrated in FIG. 2B, currents flow from input capacitor Cin (chip capacitor 130) and integrated circuit 131 that includes the FET circuits through substrate 110 in a vertical direction and reaches inductor unit 120. The currents flow from inductor unit 120 through substrate 110 in a horizontal direction, and reaches output capacitor Cout (chip capacitor 140). The currents flow from output capacitor Cout through substrate 110 in the vertical direction and reaches XPU 150.

In this manner, with the hybrid power feeding method, currents can be supplied to XPU 150 by using a combination of the currents flowing through substrate 110 in the vertical direction and the currents flowing therethrough in the horizontal direction. Since elements are mounted on both sides of substrate 110, the planar dimension of substrate 110 can be reduced. Furthermore, since the length of wiring through which currents flow is shorter, loss can be reduced.

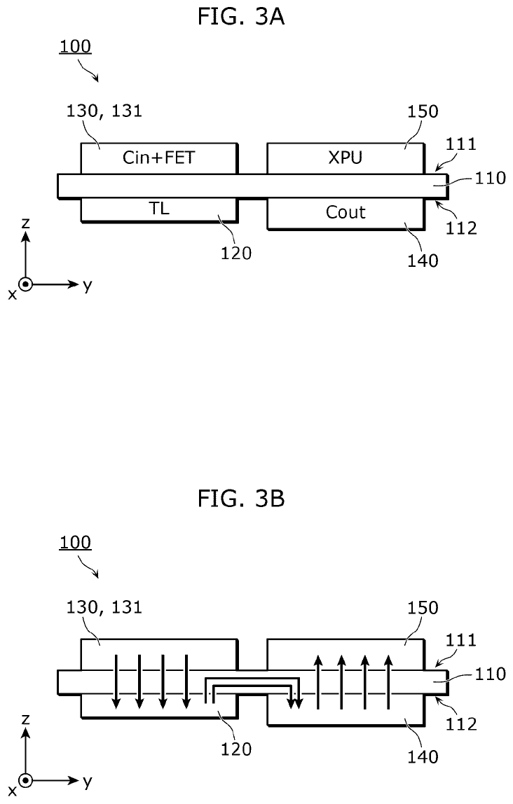

Note that a module configuration of voltage converter 100 is not limited to the examples illustrated in FIG. 2A and FIG. 2B. As illustrated in FIG. 3A, where inductor unit 120 is disposed and where chip capacitor 130 and integrated circuit 131 that includes the FET circuits are disposed may be switched. In this case, as illustrated in FIG. 3B, currents flow in a direction from principal surface 111 of substrate 110 to principal surface 112 thereof.

### 3. Configuration and Arrangement of Coupled Inductors

Next, a specific configuration and arrangement of plural coupled inductors 1 included in inductor unit 120 are to be described.

### 3-1. Example 1

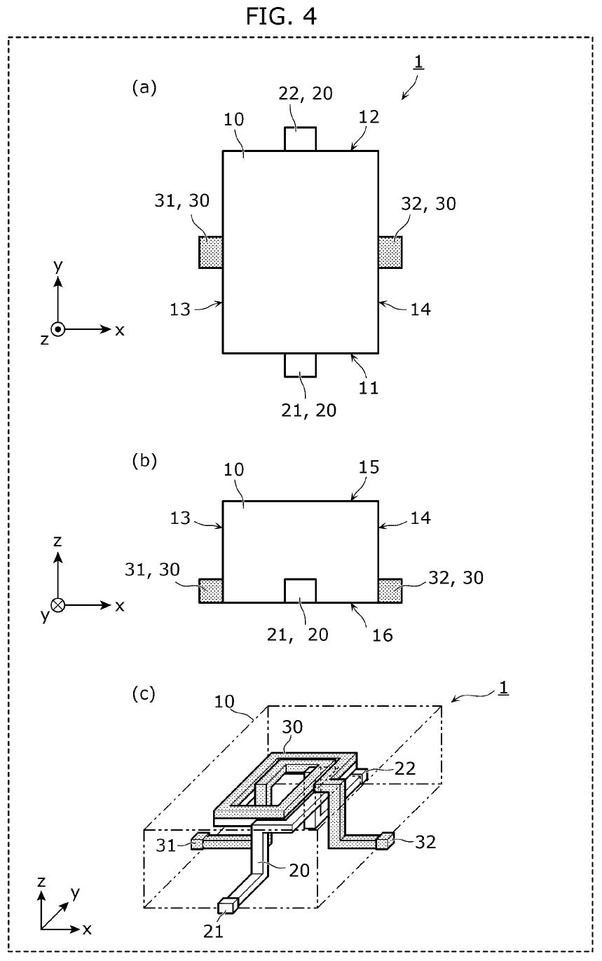

First, a specific configuration of coupled inductor 1 according to Example 1 is to be described with reference to FIG. 4.

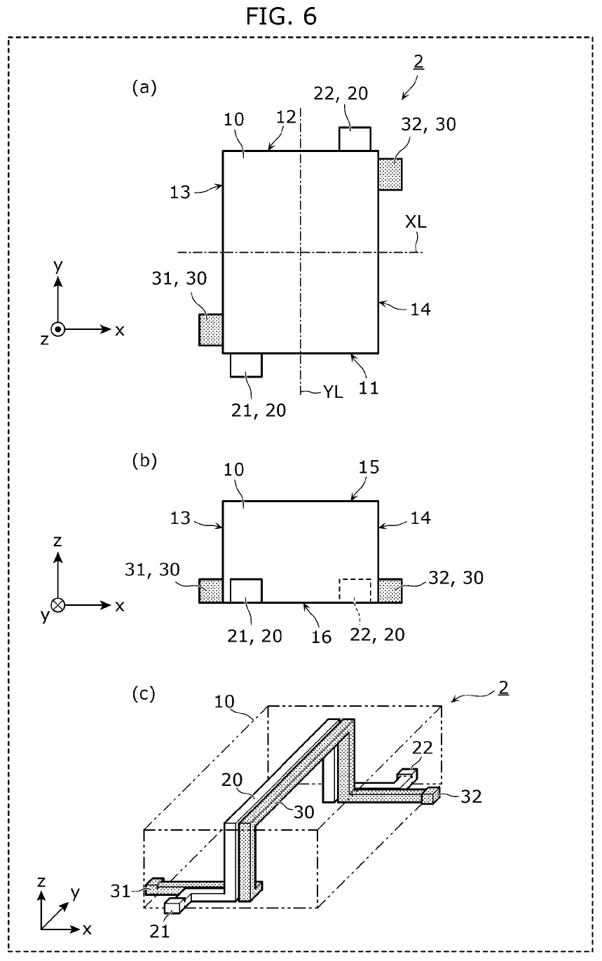

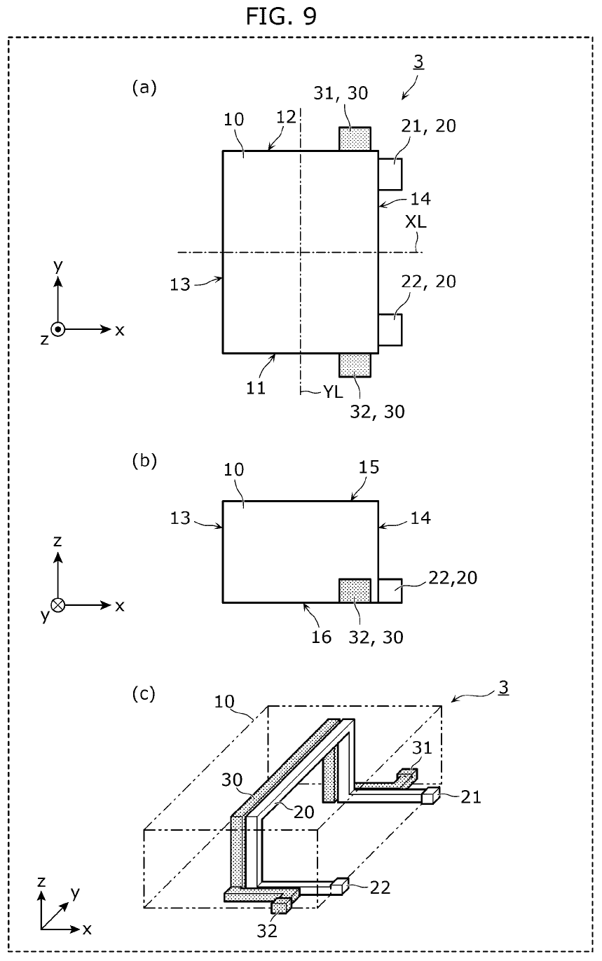

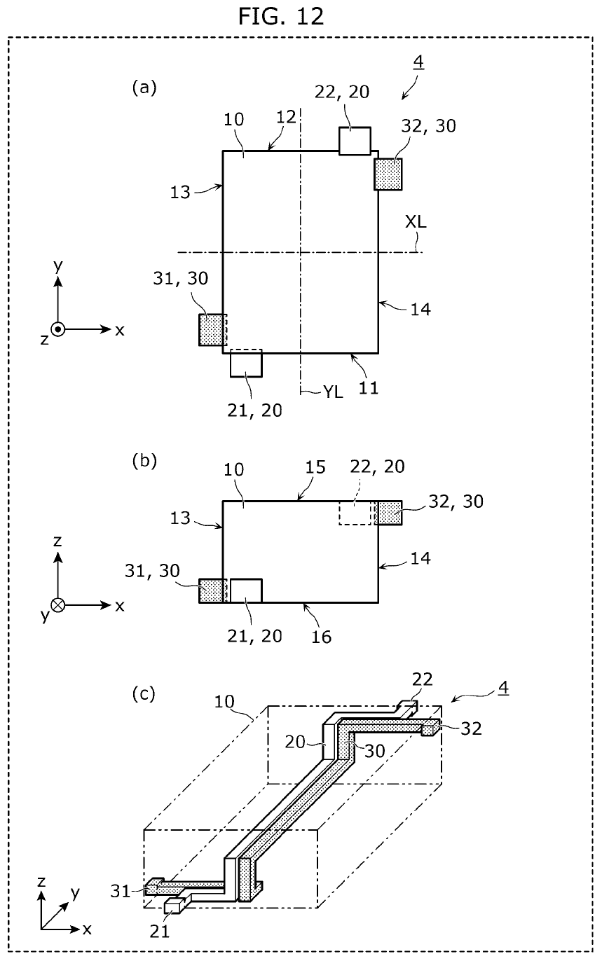

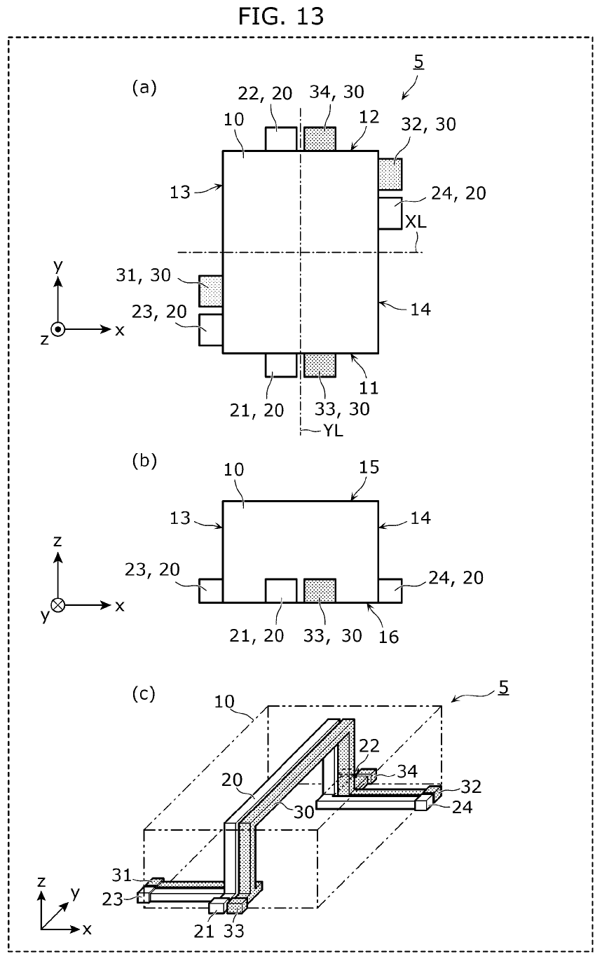

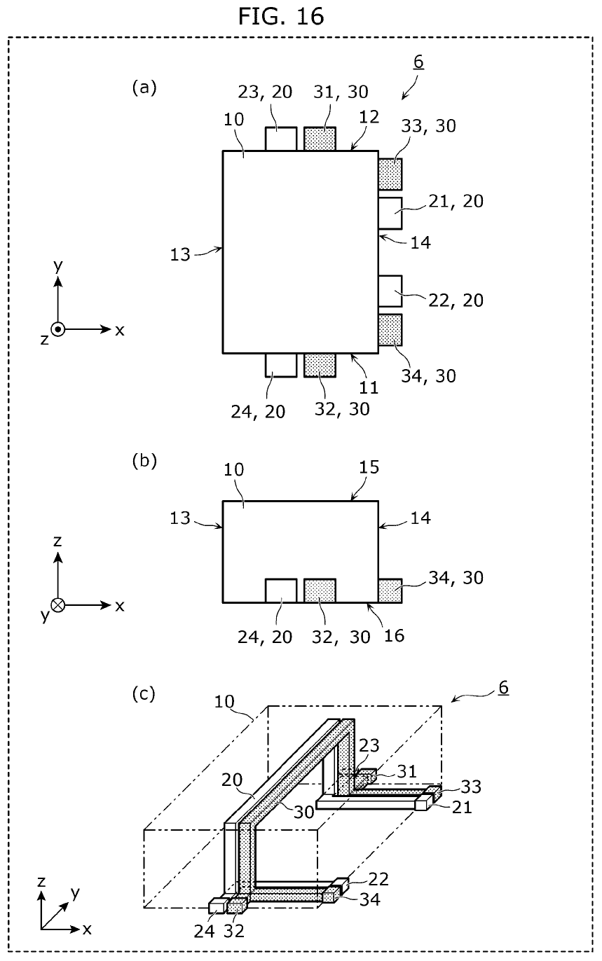

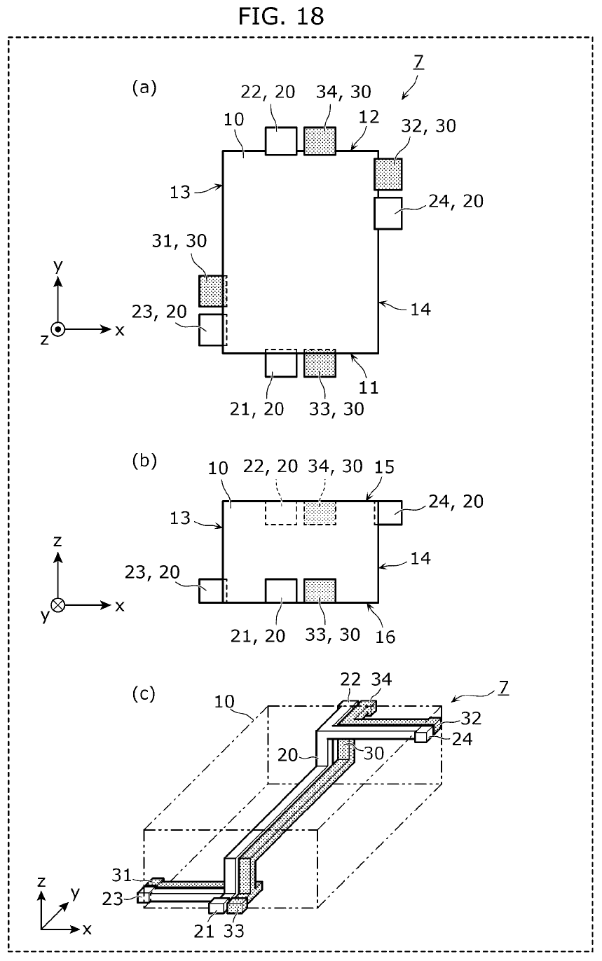

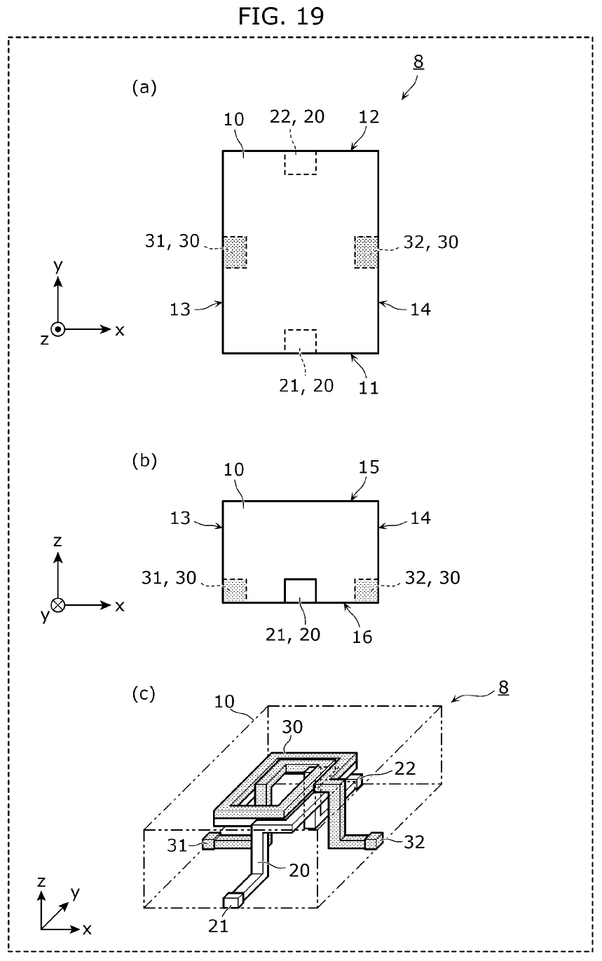

FIG. 4 includes a plan view and a front view of coupled inductor 1 according to Example 1. Part (a) of FIG. 4 is a plan view, (b) is a front view, and (c) is a perspective view. Note that the perspective view in (c) is intended to schematically show the shapes of conductors 20 and 30. Accordingly, in the perspective view, magnetic body 10 is shown with broken lines, whereas conductors 20 and 30 that are mostly invisible from the outside of magnetic body 10 are shown with solid lines. The same applies to FIG. 6, FIG. 9, FIG. 12, FIG. 13, FIG. 16, FIG. 18, and FIG. 19 later described.

In this Specification, the positive side of the z axis is defined as “upper side” or “above”, whereas the negative side of the z axis is defined as “lower side” or “below”. For example, the positive side of the z axis can be considered as a direction in which XPU 150 is disposed on substrate 110. Note that when voltage converter 100 is used, the positive side of the z axis is not limited to be the upper side. The plan view is a view when the xy plane is viewed from the positive side of the z axis. The front view is a view when the xz plane is viewed from the negative side of the y axis.

As illustrated in FIG. 4, coupled inductor 1 includes magnetic body 10 and conductors 20 and 30.

Magnetic body 10 includes lateral surfaces 11, 12, 13, and 14, upper surface 15, and lower surface 16. In this Example, lateral surface 11 is an example of a first surface. Lateral surface 12 is an example of a second surface, and faces away from lateral surface 11. Lateral surface 13 is an example of a third surface, and orthogonal to both of lateral surfaces 11 and 12. Lateral surface 14 is an example of a fourth surface, orthogonal to both of lateral surfaces 11 and 12, and furthermore faces away from lateral surface 13. Upper surface 15 is an example of a fifth surface and orthogonal to all of lateral surfaces 11, 12, 13, and 14. Lower surface 16 is orthogonal to all of lateral surfaces 11, 12, 13, and 14, and furthermore faces away from upper surface 15. In this Example, lower surface 16 is an example of a sixth surface, and faces a mounting surface (principal surface 111 or 112) of substrate 110. Lateral surfaces 11, 12, 13, and 14, upper surface 15, and lower surface 16 are all planar.

The shape of magnetic body 10 is a rectangular parallelepiped, and the distance between lateral surfaces 11 and 12 is longer than the distance between lateral surfaces 13 and 14. Note that the shape of magnetic body 10 may be a cube. The shape of magnetic body 10 may be a shape resulting from obliquely cutting off a corner portion or an edge or may be a shape resulting from round chamfering.

Magnetic body 10 includes a magnetic material. The magnetic body may include various magnetic materials such as, for example, a ferromagnetic metal (iron, for example), a ferrimagnetic compound (ferrite, for example), iron powder (carbonyl powder, for example), and a dust core made of, for instance, metal magnetic powder and resin material. For example, if a dust core is used, effects of achieving good magnetic saturation properties and flowing high currents can be yielded. Furthermore, when ferrite is used, effects of reducing core loss at high frequencies can be yielded.

Conductors 20 and 30 are provided at least partially inside magnetic body 10, and are coupled to each other. In this Example, conductor 20 is an example of a first conductor, and is a primary coil connected in series to a path that connects input terminal VIN and output terminal VOUT in FIG. 1. Conductor 20 is also referred to as a power coil. Conductor 30 is an example of a second conductor, and is a secondary coil disposed in the coupled line. Conductor 30 is also referred to as a coupling coil.

Conductor 20 includes terminals 21 and 22. Terminal 21 is a terminal on the input terminal VIN side, and terminal 22 is a terminal on the output terminal VOUT side. Specifically, as illustrated in FIG. 1, terminal 21 is connected to a connecting point of the two FETs in an FET circuit. Terminal 22 is connected to terminal VOUT.

In this Example, terminal 21 is an example of a first terminal, and is provided at lateral surface 11 of magnetic body 10. Specifically, terminal 21 protrudes from lateral surface 11. Terminal 22 is an example of a second terminal, and is provided at lateral surface 12 of magnetic body 10. Specifically, terminal 22 protrudes from lateral surface 12. Terminals 21 and 22 are two end portions of conductor 20. Thus, conductor 20 between terminals 21 and 22 at least partially passes through inside magnetic body 10. In the example illustrated in FIG. 4, terminals 21 and 22 are provided in centers on lower edges of lateral surfaces 11 and 12, respectively, but where terminals 21 and 22 are provided is not limited thereto.

Conductor 30 includes terminals 31 and 32. Terminal 31 is paired with terminal 21, and terminal 32 is paired with terminal 22. Specifically, in the circuit diagram in FIG. 1, terminal 21 and terminal 31 are in positions on the same one-end (lower-end) sides of conductors 20 and 30, respectively, whereas terminal 22 and terminal 32 are in positions on the opposite (upper-end) sides across from the one-end sides.

For example, as illustrated in FIG. 1, terminal 31 is connected to terminal 32 of coupled inductor 1 in a subsequent phase (connected to the ground in the case of phase N). Terminal 32 is connected to terminal 31 of coupled inductor 1 in a previous phase (connected to inductor Lc in the case of phase 1). Note that in FIG. 4, terminals 31 and 32 are shaded with dots so as to be readily distinguished from terminals 21 and 22. The same applies to the other drawings described later.

In this Example, terminal 31 is an example of a third terminal, and is provided at lateral surface 13 of magnetic body 10. Specifically, terminal 31 protrudes from lateral surface 13. Terminal 32 is an example of a fourth terminal, and is provided at lateral surface 14 of magnetic body 10. Specifically, terminal 32 protrudes from lateral surface 14. Terminals 31 and 32 are two end portions of conductor 30. Thus, conductor 30 between terminals 31 and 32 at least partially passes through inside magnetic body 10. In the example illustrated in FIG. 4, terminals 31 and 32 are provided in centers on lower edges of lateral surfaces 13 and 14, respectively, but where terminals 31 and 32 are provided is not limited thereto.

Lower surfaces of terminals 21, 22, 31, and 32 are flush with lower surface 16 of magnetic body 10. Accordingly, lower surface 16 is provided in contact with a mounting surface of substrate 110, so that it is possible to readily connect terminals 21, 22, 31, and 32 to wiring provided on the mounting surface of substrate 110.

Note that terminals 21, 22, 31, and 32 may also be provided at lower surface 16 of magnetic body 10. For example, terminals 21, 22, 31, and 32 may protrude from lower surface 16 or may be accommodated in recesses (grooves) provided in lower surface 16. By providing the terminals at lower surface 16, the contact area with the wiring provided on substrate 110 can be increased when coupled inductor 1 is mounted. Accordingly, contact resistance decreases, and thus loss can be reduced.

Conductor 20 and conductor 30 extend at least partially parallel to each other inside magnetic body 10, as illustrated in (c) of FIG. 4. Furthermore, conductor 20 and conductor 30 are provided in such a manner that the space between the parallel extending portions is as small as possible, for example. In this case, the longer the length of the parallel extending portions is, the stronger the coupling between conductor 20 and conductor 30 can be made. The smaller the space between the parallel extending portions of conductors 20 and 30 is, the stronger the coupling between conductor 20 and conductor 30 can be made. Hence, the coupling coefficient of coupled inductor 1 increases, so that leakage inductance can be decreased.

Conductors 20 and 30 are bent inside magnetic body 10 to increase the length of the parallel extending portions, for example. As an example, conductor 20 and conductor 30 may be bent into a U shape inside magnetic body 10 (the case of being bent at right angles is also included). For example, conductor 20 and conductor 30 extend parallel to each other along about one and half perimeters of a quadrilateral ring at different heights inside magnetic body 10 in the example illustrated in (c) of FIG. 4. For example, a portion of conductor 20 along the quadrilateral ring and a portion of conductor 30 along the quadrilateral ring overlap in a view in the z-axis direction. In this case, the start point and the end point of conductor 20 are provided as distant as possible. The same applies to the start point and the end point of conductor 30. Accordingly, interference between the magnetic field produced by parallel extending portions of conductors 20 and 30 before being bent and the magnetic field produced by parallel extending portions of conductors 20 and 30 after being bent can be reduced. In this manner, a structure that can yield a high inductance value can be acquired with saved space while reducing interference between the magnetic fields. Note that the shapes and layout of conductors 20 and 30 illustrated in (c) of FIG. 4 are mere examples.

As described above, according to coupled inductor 1 according to this example, terminals 21 and 22 of conductor 20 and terminals 31 and 32 of conductor 30 are provided at different lateral surfaces of magnetic body 10. Accordingly, deterioration of electrical properties when coupled inductors 1 are provided in multiple phases can be reduced.

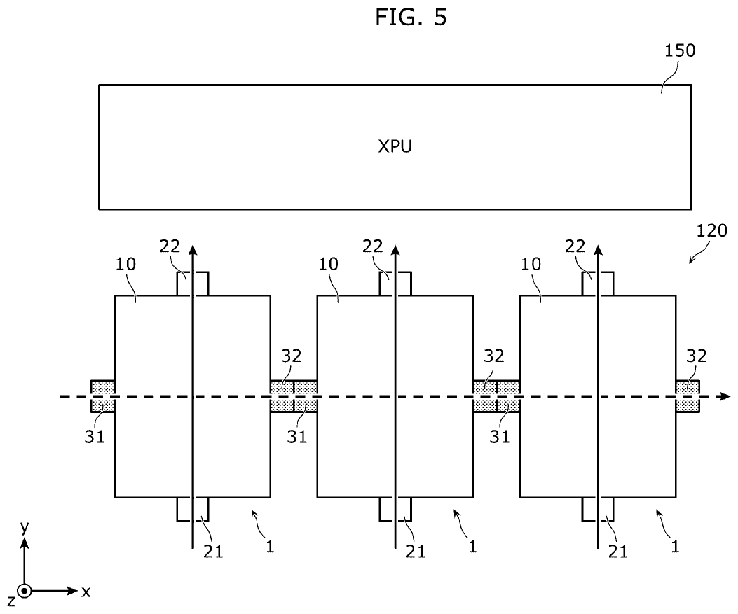

FIG. 5 is a plan view illustrating a configuration of inductor unit 120 that includes plural coupled inductors 1 each as illustrated in FIG. 4. FIG. 5 also illustrates XPU 150 that is a load. Specifically, FIG. 5 illustrates a plan view of modularized voltage converter 100 as illustrated in FIG. 2A. As described above, inductor unit 120 includes N coupled inductors 1, and the case of three coupled inductors 1 is illustrated in the drawing herein.

Plural coupled inductors 1 are aligned in an x-axis direction. Specifically, terminals to be connected to each other are provided at facing lateral surfaces of two adjacent coupled inductors 1 More specifically, two adjacent coupled inductors 1 are disposed with terminal 31 of one of the inductors being adjacent to terminal 32 of the other inductor. In this Example, terminals 31 and 32 of one coupled inductor 1 are aligned along the x axis, and thus terminals 31 and 32 of all coupled inductors 1 can be aligned in a line along the x axis. Accordingly, a circuit in which conductors 30 of N coupled inductors 1 are connected in series can be configured as shown by the broken line arrow in FIG. 5. Thus, the wiring distance between adjacent coupled inductors 1 can be shortened. For example, terminal 31 and terminal 32 may be in direct contact with each other, so that the wiring distance between adjacent coupled inductors 1 can be substantially eliminated. In this manner, since the wiring length of the coupled line can be shortened, loss can be reduced.

As shown by the solid-line arrows in FIG. 5, the directions in which currents supplied to XPU 150 flow are the same in all coupled inductors 1. Specifically, in plural coupled inductors 1, terminals 22 (lateral surfaces 12) connected to output terminal VOUT face XPU 150. Accordingly, the length of a wire that connects terminal 22 of each coupled inductor 1 and XPU 150 that is a load can be shortened.

Similarly, terminals 21 connected to the FET circuits can be aligned in the x-axis direction in plural coupled inductors 1. As illustrated in FIG. 2A, integrated circuit 131 that includes the FET circuits and input capacitor Cin (chip capacitor 130) are disposed in a position that overlaps inductor unit 120 (coupled inductors 1) in a plan view, and thus the wiring length between an FET circuit and terminal 21 can be shortened.

As described above, according to inductor unit 120 according to this example, the wiring length can be shortened, and thus loss can be reduced and furthermore, ringing can be reduced, so that operation can be stabilized. Since the wiring length is shortened, parasitic inductance decreases, and thus load responsiveness is also enhanced.

### 3-2. Example 2

Next, a specific configuration of coupled inductor 2 according to Example 2 is to be described with reference to FIG. 6. Note that in the following description, different points from Example 1 are mainly described, while description of common points is omitted or simplified.

FIG. 6 includes a plan view and a front view of coupled inductor 2 according to Example 2. Part (a) of FIG. 6 is a plan view, (b) is a front view, and (c) is a perspective view.

As illustrated in FIG. 6, the arrangement of terminals 21, 22, 31, and 32 in a plan view in coupled inductor 2 is different from the arrangement in coupled inductor 1. Specifically, a distance between terminal 21 and terminal 31 and a distance between terminal 22 and terminal 32 are shorter. More specifically, terminal 21 is provided at lateral surface 11 in a position closer to lateral surface 13 than to lateral surface 14. Terminal 22 is provided at lateral surface 12 in a position closer to lateral surface 14 than to lateral surface 13. Terminal 31 is provided at lateral surface 13 in a position closer to lateral surface 11 than to lateral surface 12. Terminal 32 is provided at lateral surface 14 in a position closer to lateral surface 12 than to lateral surface 11.

In (a) of FIG. 6, two dash-dot lines XL and YL that divide upper surface 15 of magnetic body 10 into four equal portions are shown. Two dash-dot lines XL and YL are parallel to the x axis and the y axis, respectively, and the intersection point is positioned in the center of upper surface 15. In this case, terminals 21 and 31 are disposed in a lower left region in the drawing. Terminals 22 and 32 are disposed in an upper right region in the drawing. Note that the arrangement illustrated in (a) of FIG. 6 is not limited to the one illustrated in (a) of FIG. 6, and where terminals 21, 22, 31, and 32 are disposed may be inverted with respect to dash-dot line XL or YL as an axis. The same applies to other Examples.

Thus, terminal 21 is disposed in a region closer to lateral surface 13 when lateral surface 11 is bisected along a dividing line parallel to the z axis. Terminal 31 is disposed in a region closer to lateral surface 11 when lateral surface 13 is bisected along a dividing line parallel to the z axis. Terminal 22 is disposed in a region closer to lateral surface 14 when lateral surface 12 is bisected along a dividing line parallel to the z axis. Terminal 32 is disposed in a region closer to lateral surface 12 when lateral surface 14 is bisected along a dividing line parallel to the z axis. Note that terminals 21, 22, 31, and 32 are provided with the lower surfaces thereof being flush with lower surface 16 of magnetic body 10. Alternatively, the lower surfaces of terminals 21, 22, 31, and 32 may protrude downward below lower surface 16.

By providing terminals 21 and 31 close to each other and providing terminals 22 and 32 close to each other, the coupling between conductor 20 and conductor 30 can be still strengthened. Thus, the coupling coefficient of coupled inductor 2 can be increased, and thus leakage inductance is reduced, so that load responsiveness is enhanced. Accordingly, greater latitude in designing inductor Lc is provided, and thus the inductance value of inductor Lc is readily designed.

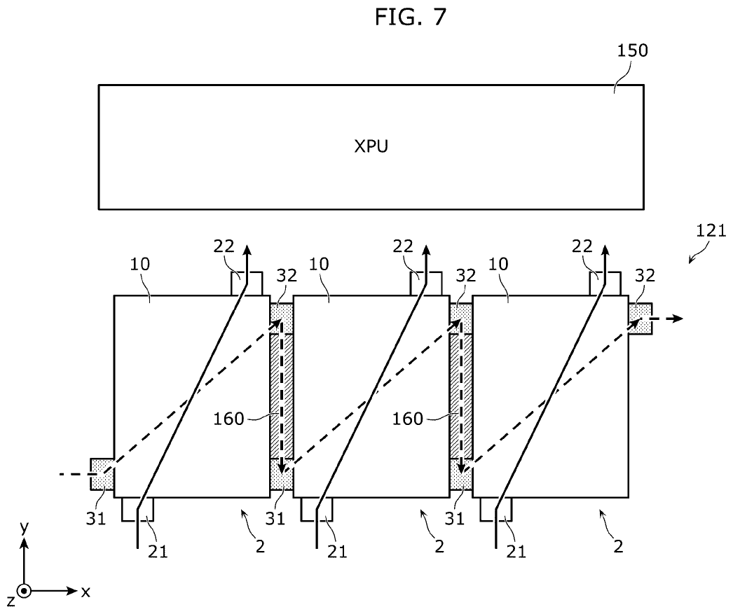

FIG. 7 is a plan view illustrating a configuration of inductor unit 121 that includes plural coupled inductors 2 each as illustrated in FIG. 6.

Plural coupled inductors 2 are aligned in an x-axis direction, as illustrated in FIG. 7. In this case, two adjacent coupled inductors 2 are disposed with terminal 31 of one of the inductors being spaced apart from terminal 32 of the other inductor. In this Example, wire 160 for connecting terminal 31 of one of the inductors and terminal 32 of the other inductor is provided on the mounting surface of substrate 110 or inside substrate 110.

Also in the example illustrated in FIG. 7, terminals to be connected to each other are provided at facing lateral surfaces of two adjacent coupled inductors 2. Accordingly, terminal 31 of one of the inductors and terminal 32 of the other inductor, which are connected to each other, can be provided close to each other, so that the wiring length can be shortened.

As illustrated in FIG. 7, terminal 31 of one of the inductors and terminal 32 of the other inductor can be aligned in the y-axis direction. Stated differently, the distance between two adjacent coupled inductors 2 can be shortened, and thus the size of inductor unit 121 can be reduced.

Note that in this Example, as illustrated in (c) of FIG. 6, conductors 20 and 30 extend parallel to each other in the z-axis direction and the y-axis direction inside magnetic body 10. Specifically, conductors 20 and 30 extend parallel to each other along three sides (that form a so-called U shape with square corners) within the cross section of magnetic body 10 parallel to the yz plane. Further, portions of conductors 20 and 30 along lower surface 16 extend parallel to each other in the x-axis direction in the vicinity of terminals 21 and 31 and in the vicinity of terminals 22 and 32. In this manner, the coupling coefficient can be increased by increasing the length of parallel extending portions inside magnetic body 10. Note that the shapes and layout of conductors 20 and 30 illustrated in (c) of FIG. 6 are mere examples.

### 3-3. Example 3

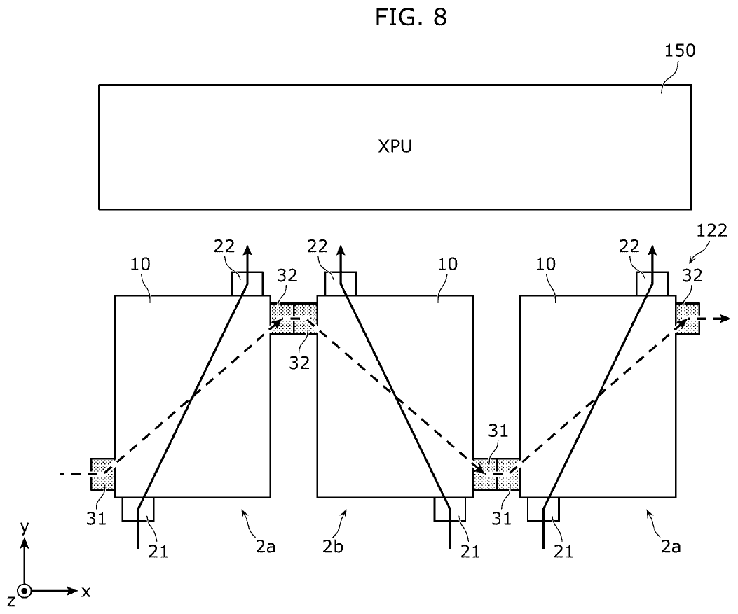

Next, a specific configuration of an inductor unit according to Example 3 is to be described with reference to FIG. 8. Note that in the following description, different points from Example 2 are mainly described, while description of common points is omitted or simplified.

FIG. 8 is a plan view illustrating a configuration of inductor unit 122 according to Example 3. Coupled inductors 2 having the same configuration are aligned in Example 2, whereas in this Example, two types of coupled inductors 2a and 2b having different configurations are alternately aligned as illustrated in FIG. 8.

Coupled inductor 2a is an example of a first coupled inductor, and has the same configuration as that of coupled inductor 2 according to Example 2. Coupled inductor 2b is an example of a second coupled inductor, and has a mirror-inverted structure as the structure of coupled inductor 2a. Specifically, coupled inductor 2b has a mirror-inverted structure of coupled inductor 2, with the yz plane at the position of dash-dot line YL illustrated in (a) of FIG. 6 as a mirror plane. Accordingly, in coupled inductor 2b, terminals 21 and 31 are disposed in a lower right region in the drawing out of the four regions equally divided by two dash-dot lines XL and YL. Terminals 22 and 32 are disposed in the upper left region in the drawing.

By alternately disposing coupled inductors 2a and 2b, two terminals 31 and two terminals 32 can be directly connected to each other, as illustrated in FIG. 8. Thus, a wire between coupled inductors 2a and 2b is unnecessary, so that the wiring length can be further shortened.

As described above according to inductor unit 122 according to this Example, the wiring length can be shortened, and thus loss can be reduced and furthermore, ringing can be reduced, so that operation can be stabilized. Since the wiring length is shortened, parasitic inductance decreases, and thus load responsiveness is also enhanced.

### 3-4. Example 4

Next, a specific configuration of coupled inductor 3 according to Example 4 is to be described with reference to FIG. 9. Note that in the following description, different points from Example 2 are mainly described, while description of common points is omitted or simplified.

FIG. 9 includes a plan view and a front view of coupled inductor 3 according to Example 4. Part (a) of FIG. 9 is a plan view, (b) is a front view, and (c) is a perspective view.

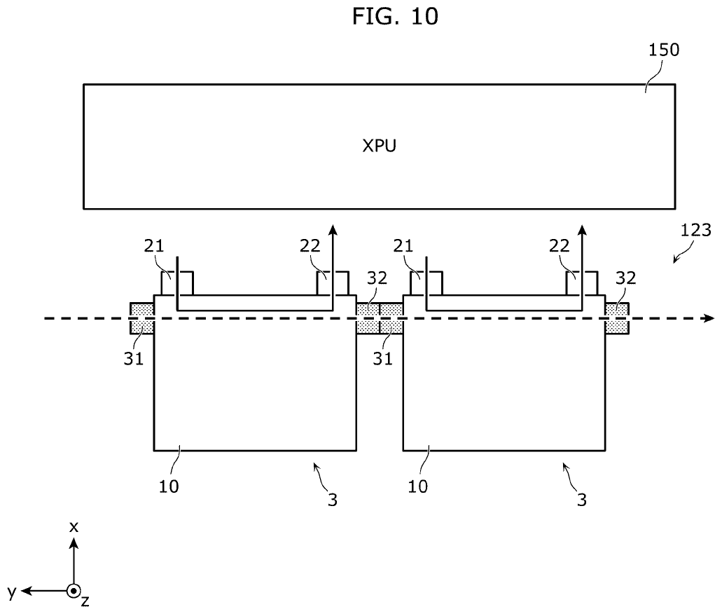

As illustrated in FIG. 9, the arrangement of terminals 21, 22, 31, and 32 in a plan view in coupled inductor 3 is different from the arrangement in coupled inductor 2. In this Example, terminals 21 and 22 are provided at same lateral surface 14 of magnetic body 10. Lateral surface 14 is closer to a load (XPU 150, for example) that receives supply of a current flowing through conductor 20 (refer to FIG. 10) than lateral surface 13 is. Terminal 31 is provided at lateral surface 12. Terminal 32 is provided at lateral surface 11.

In this Example, similarly to Examples 2 and 3, the arrangement is made in such a manner that a distance between terminal 21 and terminal 31 and a distance between terminal 22 and terminal 32 are shortened. Specifically, terminals 21 and 31 are disposed in an upper right region in the drawing out of the four regions equally divided by two dash-dot lines XL and YL. Terminals 22 and 32 are disposed in the lower right region in the drawing.

FIG. 10 is a plan view illustrating a configuration of inductor unit 123 that includes plural coupled inductors 3 each as illustrated in FIG. 9.

Plural coupled inductors 3 are aligned in the y-axis direction, as illustrated in FIG. 10. Specifically, terminals to be connected to each other are provided at facing lateral surfaces of two adjacent coupled inductors 3. More specifically, two adjacent coupled inductors 3 are disposed with terminal 31 of one of the inductors being adjacent to terminal 32 of the other inductor. In this Example, terminals 31 and 32 of one coupled inductor 3 are aligned along the y axis, and thus terminals 31 and 32 of all coupled inductors 3 can be disposed in a line along the y axis. Accordingly, a circuit in which conductors 30 of N coupled inductors 3 are connected in series can be configured as shown by the broken line arrow in FIG. 10. Thus, a wiring distance between adjacent coupled inductors 3 can be shortened. For example, terminal 31 and terminal 32 may be in direct contact with each other, so that the wiring distance between adjacent coupled inductors 3 can be substantially eliminated. In this manner, since the wiring length of the coupled line can be shortened, loss can be reduced.

As shown by the solid-line arrows in FIG. 10, the directions in which currents supplied to XPU 150 flow are the same in all coupled inductors 3. Specifically, in plural coupled inductors 3, terminals 22 (lateral surfaces 14) connected to output terminal VOUT face XPU 150. Accordingly, the length of a wire that connects terminal 22 of each coupled inductor 3 and XPU 150 that is a load can be shortened.

Similarly, plural coupled inductors 3 are disposed with also terminals 21 connected to the FET circuits facing XPU 150. Similarly to inductor unit 120 (coupled inductors 1) illustrated in FIG. 2A, integrated circuit 131 that includes the FET circuits and input capacitor Cin (chip capacitor 130) are disposed in a position that overlaps coupled inductors 3 in a plan view, and thus the wiring length between the FET circuits and terminals 21 can be shortened.

As described above according to inductor unit 123 according to this Example, the wiring length can be shortened, and thus loss can be reduced and furthermore, ringing can be reduced, so that operation can be stabilized. Since the wiring length is shortened, parasitic inductance decreases, and thus load responsiveness is also enhanced.

Note that in this Example, as illustrated in (c) of FIG. 9, conductors 20 and 30 extend parallel to each other in the z-axis direction and the y-axis direction inside magnetic body 10, similarly to (c) of FIG. 6. Specifically, conductors 20 and 30 extend parallel to each other along three sides (that form a so-called U shape with square corners) within the cross section of magnetic body 10 parallel to the yz plane. Further, portions of conductors 20 and 30 along lower surface 16 extend parallel to each other in the x-axis direction in the vicinity of terminals 21 and 31 and in the vicinity of terminals 22 and 32. In this manner, the coupling coefficient can be increased by increasing the distance of parallel extending portions inside magnetic body 10. Note that the shapes and layout of conductors 20 and 30 illustrated in (c) of FIG. 9 are mere examples.

### 3-5. Example 5

Next, a specific configuration of coupled inductor 4 (refer to FIG. 12) according to Example 5 is to be described. Note that in the following description, different points from Example 2 are mainly described, while description of common points is omitted or simplified.

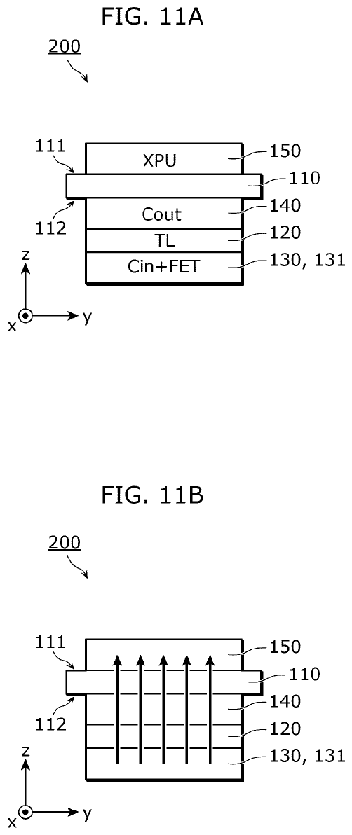

In all Examples 1 to 4 described above, coupled inductors suitable for voltage converter 100 that adopts the hybrid power feeding method has been described as an example, but coupled inductor 4 according to Example 5 is suitable for a voltage converter that adopts the vertical power feeding method. In the following, first, a configuration of a voltage converter that adopts the vertical power feeding method is to be described with reference to FIG. 11A and FIG. 11B.

FIG. 11A is a schematic diagram illustrating an example of a configuration of voltage converter 200 that adopts the vertical power feeding method. FIG. 11B is a diagram for describing a method of feeding power by voltage converter 200 illustrated in FIG. 11A.

As illustrated in FIG. 11A, voltage converter 200 is mounted on substrate 110. XPU 150 that is an example of a load is disposed on principal surface 111 of substrate 110. Chip capacitors 130 and 140, inductor unit 120, and integrated circuit 131 that includes the FET circuits are disposed and stacked below principal surface 112.

Inductor unit 120 includes plural coupled inductors 4. Specific arrangement of plural coupled inductors 4 is to be described later. Inductor unit 120 is disposed between (i) chip capacitor 130 and integrated circuit 131 that includes the FET circuits and (ii) chip capacitor 140. In this Example, inductor unit 120 overlaps, in a plan view, XPU 150, chip capacitor 140, chip capacitor 130, and integrated circuit 131 that includes the FET circuits. Accordingly, the mounting area in substrate 110 can be reduced, and thus the size of voltage converter 200 can be reduced.

FIG. 11B shows a direction of currents with arrows. As illustrated in FIG. 11B, currents flow from input capacitor Cin (chip capacitor 130) and integrated circuit 131 that includes the FET circuits through inductor unit 120, output capacitor Cout (chip capacitor 140), and substrate 110 in this order, and reach XPU 150. Accordingly, by causing currents to flow in the thickness direction of substrate 110, that is, the vertical direction, power can be fed to XPU 150 (vertical power feeding).

Plural coupled inductors 4 included in inductor unit 120 are connected to the FET circuits and input capacitor Cin at lower surface 16 and connected to output capacitor Cout at upper surface 15. Accordingly, in each coupled inductor 4, terminals 21, 22, 31, and 32 are each provided at upper surface 15 or lower surface 16. In the following, a specific configuration of coupled inductor 4 is to be described with reference to FIG. 12.

FIG. 12 includes a plan view and a front view of coupled inductor 4 according to Example 5. Part (a) of FIG. 12 is a plan view, (b) is a front view, and (c) is a perspective view.

As illustrated in (b) of FIG. 12, in this Example, terminals 21 and 31 are provided at lower surface 16, whereas terminals 22 and 32 are provided at upper surface 15.

Specifically, terminal 21 is continuously provided at lateral surface 11 and lower surface 16. More specifically, terminal 21 protrudes from lateral surface 11 and is embedded in lower surface 16. The lower surface of terminal 21 and lower surface 16 of magnetic body 10 are flush with each other. Terminal 21 may protrude downward from lower surface 16.

Terminal 31 is continuously provided at lateral surface 13 and lower surface 16. Specifically, terminal 31 protrudes from lateral surface 13 and is embedded in lower surface 16. The lower surface of terminal 31 and lower surface 16 of magnetic body 10 are flush with each other. Terminal 31 may protrude downward from lower surface 16.

Terminals 21 and 31 are disposed in a lower left region out of the four regions equally divided by two dash-dot lines XL and YL, similarly, to Example 2. Note that terminals 21 and 31 may be disposed in centers on lower edges of lateral surfaces 11 and 13, respectively, similarly to Example 1.

Terminal 22 is continuously provided at lateral surface 12 and upper surface 15. Specifically, terminal 22 protrudes from lateral surface 12 and is embedded in upper surface 15. The upper surface of terminal 22 and upper surface 15 of magnetic body 10 are flush with each other. Terminal 22 may protrude upward from upper surface 15.

Terminal 32 is continuously provided at lateral surface 14 and upper surface 15. Specifically, terminal 32 protrudes from lateral surface 14 and is embedded in upper surface 15. The upper surface of terminal 32 and upper surface 15 of magnetic body 10 are flush with each other. Terminal 32 may protrude upward from upper surface 15.

Terminals 22 and 32 are disposed in an upper right region out of the four regions equally divided by two dash-dot lines XL and YL, similarly, to Example 2. Note that terminals 22 and 32 may be disposed in centers on upper edges of lateral surfaces 12 and 14 (on dash-dot lines XL and YL), respectively.

Plural coupled inductors 4 according to this Example are aligned in the x-axis direction in a plan view, similarly to Example 2 illustrated in FIG. 7. Alternatively, two adjacent ones of plural coupled inductors 4 may have a mirror-inverted structure, similarly to Example 3 illustrated in FIG. 8.

In coupled inductor 4, terminals 21, 22, 31, and 32 are provided at upper surface 15 or lower surface 16 of magnetic body 10. Accordingly, input capacitor Cin and the FET circuits, which are disposed below plural coupled inductors 4, and terminals 21 can be connected with short wires or directly connected to one another. Similarly, output capacitor Cout disposed above coupled inductors 4 and terminals 22 can be connected with short wires or directly connected to one another.

Plural coupled inductors 4 may be stacked in the vertical direction (up-and-down direction). Since terminals 31 and 32 are provided at upper surface 15 or lower surface 16, terminal 31 of one inductor and terminal 32 of another inductor can be connected with a short wire or directly connected to each other. Accordingly, the wiring length of the coupled line can be shortened.

Note that terminal 21 may not be provided at lateral surface 11. Thus, terminal 21 may not protrude from lateral surface 11. Similarly, terminal 22 may not be provided at lateral surface 12. Thus, terminal 22 may not protrude from lateral surface 12. Terminal 31 may not be provided at lateral surface 13. Thus, terminal 31 may not protrude from lateral surface 13. Terminal 32 may not be provided at lateral surface 14. Thus, terminal 32 may not protrude from lateral surface 14. Terminals 21, 22, 31, and 32 may not protrude outward from the perimeter of upper surface 15 or lower surface 16.

In this Example, terminals 21 and 31 are close to each other, and terminal 22 and terminal 32 are close to each other, and thus a high coupling coefficient can be achieved, yet where the terminals are provided is not limited thereto. For example, terminals 31 and 32 included in a secondary coil (coupled line) may not be provided at any of upper surface 15 or lower surface 16. For example, terminal 31 may be provided in a center of lateral surface 13, and terminal 32 may be provided in a center of lateral surface 14.

Note that in this Example, as illustrated in (c) of FIG. 12, conductors 20 and 30 extend parallel to each other in the x-axis direction, the y-axis direction, and the z-axis direction inside magnetic body 10. Specifically, conductors 20 and 30 extend in the z-axis direction at the two end portions of magnetic body 10 in the y-axis direction and furthermore, extend parallel to each other in the y-axis direction in substantially the center of magnetic body 10 in the z-axis direction. Moreover, portions of conductors 20 and 30 along lower surface 16 extend parallel to each other in the x-axis direction in the vicinity of terminals 21 and 31. Further, portions of conductors 20 and 30 along upper surface 15 extend parallel to each other in the x-axis direction in the vicinity of terminals 22 and 32. In this manner, the coupling coefficient can be increased by increasing the distance of parallel extending portions inside magnetic body 10. Note that the shapes and layout of conductors 20 and 30 illustrated in (c) of FIG. 12 are mere examples.

### 3-6. Example 6

Next, a configuration of coupled inductor 5 according to Example 6 is to be described with reference to FIG. 13. Note that in the following description, different points from Example 1 are mainly described, while description of common points is omitted or simplified.

FIG. 13 includes a plan view and a front view of coupled inductor 5 according to Example 6. Part (a) of FIG. 13 is a plan view, (b) is a front view, and (c) is a perspective view.

As illustrated in FIG. 13, in coupled inductor 5, conductor 20 includes terminals 23 and 24 in addition to terminals 21 and 22. Conductor 30 includes terminals 33 and 34 in addition to terminals 31 and 32. Thus, conductors 20 and 30 each include four terminals.

As described above, terminals 21 and 22 are used to connect the FET circuit and output terminal VOUT, whereas terminals 31 and 32 are used to be connected to terminals 31 and 32 of adjacent coupled inductors 5. On the other hand, terminals 23, 24, 33, and 34 are not used to be connected to other elements or terminals, for instance. Terminals 23, 24, 33, and 34 are auxiliary terminals provided to strengthen the coupling between conductors 20 and 30.

As illustrated in FIG. 13, terminal 23 of conductor 20 is an example of a fifth terminal, and is provided at the same surface as the surface at which terminal 31 of conductor 30 is provided, that is, lateral surface 13. Terminal 23 is disposed in proximity to terminal 31. For example, terminal 23 is provided at lateral surface 13 in a position closer to lateral surface 11 than to lateral surface 12, similarly to terminal 31. Thus, terminal 23 is disposed in a lower left region out of the four regions equally divided by two dash-dot lines XL and YL.

Terminal 24 of conductor 20 is an example of a sixth terminal, and is provided at the same surface as the surface at which terminal 32 of conductor 30 is provided, that is, lateral surface 14. Terminal 24 is disposed in proximity to terminal 32. For example, terminal 24 is provided at lateral surface 14 in a position closer to lateral surface 12 than to lateral surface 11, similarly to terminal 32. Thus, terminal 24 is disposed in an upper right region out of the four regions equally divided by two dash-dot lines XL and YL.

Note that “in proximity” means being sufficiently close but not touching, but the meaning is not limited thereto. For example, terminal A and terminal B being in proximity also means that a distance between terminal A and terminal B is shorter than both of a distance between terminal A and any terminal other than terminal B and a distance between terminal B and any terminal other than terminal A. Stated differently, terminals in proximity to each other are terminals closest to each other out of all the terminals included in a coupled inductor.

Terminal 33 of conductor 30 is an example of a seventh terminal, and is provided at the same surface as the surface at which terminal 21 of conductor 20 is provided, that is, lateral surface 11. Terminal 33 is disposed in proximity to terminal 21. For example, terminal 33 is aligned with terminal 21 in a center of a lower edge of lateral surface 11.

Terminal 34 of conductor 30 is an example of an eighth terminal, and is provided at the same surface as the surface at which terminal 22 of conductor 20 is provided, that is, lateral surface 12. Terminal 34 is disposed in proximity to terminal 22. For example, terminal 34 is aligned with terminal 22 in a center of a lower edge of lateral surface 12.

Lower surfaces of terminals 21 to 24 and 31 to 34 are flush with lower surface 16 of magnetic body 10. Alternatively, the lower surfaces of terminals 21 to 24 and 31 to 34 may protrude downward below lower surface 16.

As described above, terminals 33 and 34 of conductor 30 are disposed in proximity to terminals 21 and 22 of conductor 20, respectively, and terminals 31 and 32 of conductor 30 are disposed in proximity to terminals 23 and 24 of conductor 20, respectively. Accordingly, the length of parallel extending portions of conductor 20 and conductor 30 can be increased, and thus the coupling between conductors 20 and 30 can be strengthened. Hence, coupled inductor 5 can achieve a high coupling coefficient, and thus leakage inductance is decreased. Accordingly, greater latitude in designing inductor Lc is provided, so that the inductance value of inductor Lc is readily designed.

Note that in this Example, as illustrated in (c) of FIG. 13, conductors 20 and 30 extend parallel to each other in the x-axis direction, the y-axis direction, and the z-axis direction inside magnetic body 10. Specifically, conductors 20 and 30 extend parallel to each other along three sides (that form a so-called U shape with square corners) within a cross section of magnetic body 10 parallel to the yz plane. Furthermore, portions of conductors 20 and 30 along lower surface 16 extend parallel to each other in the y-axis direction in the vicinity of terminals 21 and 33 and in the vicinity of terminals 22 and 34. Moreover, portions of conductors 20 and 30 along lower surface 16 extend parallel to each other in the x-axis direction in the vicinity of terminals 23 and 31 and in the vicinity of terminals 24 and 32. In this manner, the coupling coefficient can be increased by increasing the length of parallel extending portions inside magnetic body 10. Note that the shapes and layout of conductors 20 and 30 illustrated in (c) of FIG. 13 are mere examples.

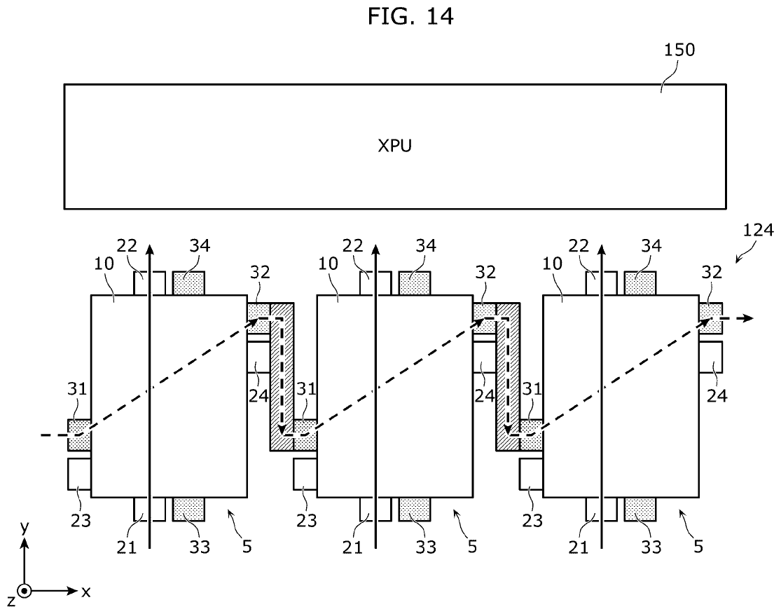

FIG. 14 is a plan view illustrating a configuration of inductor unit 124 that includes plural coupled inductors 5 each as illustrated in FIG. 13.

Plural coupled inductors 5 are aligned in an x-axis direction, as illustrated in FIG. 14. In this case, two adjacent coupled inductors 5 are disposed with terminal 31 of one of the inductors being spaced apart from terminal 32 of the other inductor. In this Example, wire 160 for connecting terminal 31 of one of the inductors and terminal 32 of the other inductor is provided on the mounting surface of substrate 110 or inside substrate 110.

Also in the example illustrated in FIG. 14, terminals to be connected to each other are provided at facing lateral surfaces of two adjacent coupled inductors 5. Accordingly, terminal 31 of one of the inductors and terminal 32 of the other inductor, which are connected to each other, can be provided close to each other, so that the wiring length can be shortened.

As illustrated in FIG. 14, terminal 31 of one of the inductors and terminal 32 of the other inductor can be aligned in the y-axis direction. Thus, since the distance between two adjacent coupled inductors 5 can be shortened, the size of inductor unit 124 can be reduced.

### 3-7. Example 7

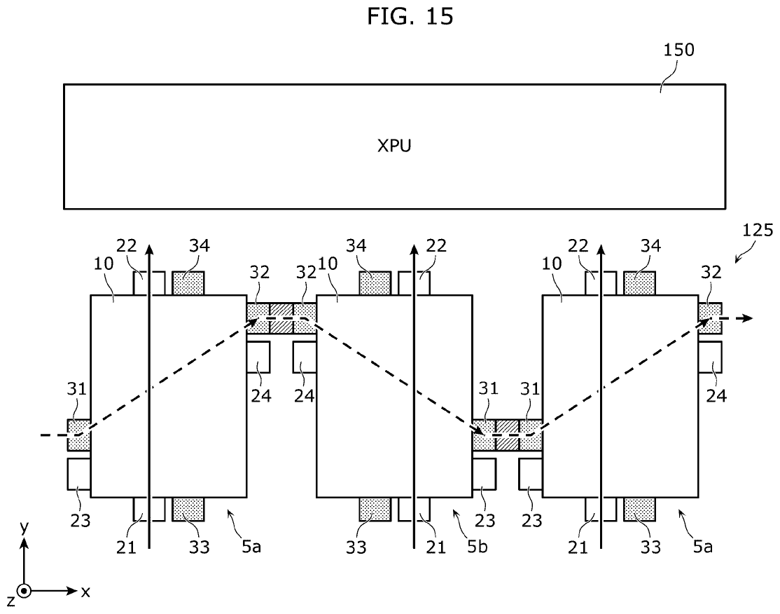

Next, a specific configuration of an inductor unit according to Example 7 is to be described with reference to FIG. 15. Note that in the following description, different points from Example 6 are mainly described, while description of common points is omitted or simplified.

FIG. 15 is a plan view illustrating a configuration of inductor unit 125 according to Example 7. Coupled inductors 5 having the same configuration are aligned in Example 6, whereas in this Example, two types of coupled inductors 5a and 5b having different configurations are alternately aligned as illustrated in FIG. 15.

Coupled inductor 5a is an example of a first coupled inductor, and has the same configuration as that of coupled inductor 5 according to Example 6. Coupled inductor 5b is an example of a second coupled inductor, and has a mirror-inverted structure of the structure of coupled inductor 5a. Specifically, coupled inductor 5b has a mirror-inverted structure of coupled inductor 5, with the yz plane at the position of dash-dot line YL illustrated in (a) of FIG. 13 as a mirror plane. Accordingly, in coupled inductor 5b, terminals 23 and 31 are disposed in a lower right region in the drawing out of the four regions equally divided by two dash-dot lines XL and YL. Terminals 24 and 32 are disposed in the upper left region in the drawing.

By alternately disposing coupled inductors 5a and 5b, two terminals 31 and two terminals 32 can be connected with shorter wires, as illustrated in FIG. 15. Thus, a wire between coupled inductors 5a and 5b is unnecessary, so that the wiring length can be further shortened.

As described above according to inductor unit 125 according to this Example, the wiring length can be shortened, and thus loss can be reduced and furthermore, ringing can be reduced, so that operation can be stabilized. Since the wiring length is shortened, parasitic inductance decreases, and thus load responsiveness is also enhanced.

### 3-8. Example 8

Next, a specific configuration of coupled inductor 6 according to Example 8 is to be described with reference to FIG. 16. Note that in the following description, different points from Example 6 are mainly described, while description of common points is omitted or simplified.

FIG. 16 includes a plan view and a front view of coupled inductor 6 according to Example 8. Part (a) of FIG. 16 is a plan view, (b) is a front view, and (c) is a perspective view.

As illustrated in FIG. 16, the arrangement of terminals 21 to 24 and 31 to 34 in a plan view in coupled inductor 6 is different from the arrangement in coupled inductor 5. In coupled inductor 6, auxiliary terminals are disposed in proximity to the terminals of coupled inductor 3 according to Example 4.

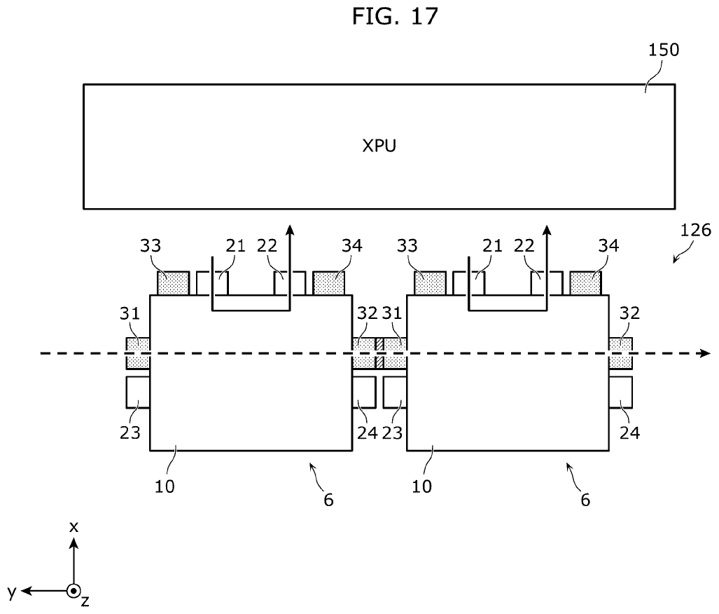

In this Example, terminals 21 and 22 are provided at same lateral surface 14 of magnetic body 10. Lateral surface 14 is closer to a load (XPU 150, for example) that receives supply of a current flowing through conductor 20 (refer to FIG. 17), than lateral surface 13 is.

Terminals 33 and 34 included in conductor 30 are disposed in proximity to terminals 21 and 22. Terminals 33 and 34 are provided at the same surface as the surface at which terminals 21 and 22 are provided, that is, lateral surface 14.

In this Example, terminal 31 is provided at lateral surface 12. Terminal 23 included in conductor 20 is provided in proximity to terminal 31. Terminal 32 is provided at lateral surface 11. Terminal 24 included in conductor 20 is provided in proximity to terminal 32.

FIG. 17 is a plan view illustrating a configuration of inductor unit 126 that includes plural coupled inductors 6 each as illustrated in FIG. 16. Plural coupled inductors 6 are disposed similarly to plural coupled inductors 3 according to Example 4 illustrated in FIG. 10. Accordingly, similarly to Example 4, the wiring length can be shortened, and thus loss can be reduced and furthermore, ringing can be reduced, so that operation can be stabilized. Since the wiring length is shortened, parasitic inductance decreases, and thus load responsiveness is also enhanced. Further, since terminals 23, 24, 33, and 34 are provided as auxiliary terminals, coupling coefficients of coupled inductors 6 are increased. Thus, leakage inductance is decreased, and thus greater latitude in designing inductor Lc is provided, so that the inductance value of inductor Lc is readily designed.

Note that in this Example, as illustrated in (c) of FIG. 16, conductors 20 and 30 extend parallel to each other in the x-axis direction, the y-axis direction, and the z-axis direction inside magnetic body 10. Specifically, conductors 20 and 30 have shapes resulting from combining the example illustrated in (c) of FIG. 9 and the example illustrated in (c) of FIG. 13. In this manner, the coupling coefficient can be increased by increasing the length of parallel extending portions inside magnetic body 10. Note that the shapes and layout of conductors 20 and 30 illustrated in (c) of FIG. 16 are mere examples.

### 3-9. Example 9

Next, a specific configuration of coupled inductor 7 according to Example 9 is to be described. Note that in the following description, different points from Example 6 are mainly described, while description of common points is omitted or simplified.

FIG. 18 includes a plan view and a front view of coupled inductor 7 according to Example 9. Part (a) of FIG. 18 is a plan view, (b) is a front view, and (c) is a perspective view. The plan view of coupled inductor 7 is similar to the plan view of coupled inductor 5 according to Example 6 illustrated in (a) of FIG. 13. In this Example, as illustrated in (b) of FIG. 18, terminals 21, 23, 31, and 33 are provided at lower surface 16, whereas terminals 22, 24, 32, and 34 are provided at upper surface 15. Thus, coupled inductor 7 has a configuration suitable for a voltage converter that adopts the vertical power feeding method, similarly to Example 4.

Specifically, terminals 21 and 33 are continuously provided at lateral surface 11 and lower surface 16. More specifically, terminals 21 and 33 protrude from lateral surface 11 and are embedded in lower surface 16. The lower surfaces of terminals 21 and 33 and lower surface 16 of magnetic body 10 are flush with one another. Terminals 21 and 33 may protrude downward from lower surface 16.

Terminals 31 and 23 are continuously provided at lateral surface 13 and lower surface 16. Specifically, terminals 31 and 23 protrude from lateral surface 13 and are embedded in lower surface 16. The lower surfaces of terminals 31 and 23 and lower surface 16 of magnetic body 10 are flush with one another. Terminals 31 and 23 may protrude downward from lower surface 16.

Terminals 22 and 34 are continuously provided at lateral surface 12 and upper surface 15. Specifically, terminals 22 and 34 protrude from lateral surface 12 and are embedded in upper surface 15. The upper surfaces of terminals 22 and 34 and upper surface 15 of magnetic body 10 are flush with one another. Terminals 22 and 34 may protrude upward from upper surface 15.

Terminals 32 and 24 are continuously provided at lateral surface 14 and upper surface 15. Specifically, terminals 32 and 24 protrude from lateral surface 14 and are embedded in upper surface 15. The upper surfaces of terminals 32 and 24 and upper surface 15 of magnetic body 10 are flush with one another. Terminals 32 and 24 may protrude upward from upper surface 15.

Plural coupled inductors 7 according to this Example are aligned in the x-axis direction in a plan view, similarly to Example 6 illustrated in FIG. 14. Alternatively, two adjacent ones of plural coupled inductors 7 may have a mirror-inverted structure, similarly to Example 7 illustrated in FIG. 15.

In coupled inductor 7, terminals 21, 22, 31, and 32 are provided at upper surface 15 or lower surface 16 of magnetic body 10. Accordingly, input capacitor Cin and the FET circuits, which are disposed below plural coupled inductors 7, and terminals 21 can be connected with short wires or directly connected to one another. Similarly, output capacitor Cout disposed above coupled inductors 7 and terminals 22 can be connected with short wires or directly connected to one another.

Plural coupled inductors 7 may be stacked in the vertical direction (up-and-down direction). Since terminals 31 and 32 are provided on upper surface 15 or lower surface 16, terminal 31 of one inductor and terminal 32 of another inductor can be connected with a short wire or directly connected to each other. Accordingly, the wiring length of the coupled line can be shortened.

Note that in this Example, terminal 21 and terminal 31 are close to each other and terminal 22 and terminal 32 are close to each other, and thus a high coupling coefficient can be achieved, but where the terminals are disposed is not limited thereto. For example, terminals 31 and 32 included in a secondary coil (coupled line) may not be provided at any of upper surface 15 or lower surface 16. For example, terminal 31 may be provided in a center of lateral surface 13, and terminal 32 may be provided in a center of lateral surface 14. For example, terminals 23, 24, 33, and 34 that are used as auxiliary terminals may not be provided at upper surface 15 or lower surface 16.

Note that in this Example, as illustrated in (c) of FIG. 18, conductors 20 and 30 extend parallel to each other in the x-axis direction, the y-axis direction, and the z-axis direction inside magnetic body 10. Specifically, conductors 20 and 30 have shapes resulting from combining the example illustrated in (c) of FIG. 12 and the example illustrated in (c) of FIG. 13. In this manner, the coupling coefficient can be increased by increasing the length of parallel extending portions inside magnetic body 10. Note that the shapes and layout of conductors 20 and 30 illustrated in (c) of FIG. 18 are mere examples.

### 3-10. Example 10

Next, a specific configuration of coupled inductor 8 according to Example 10 is to be described with reference to FIG. 19. Note that in the following description, different points from Example 1 are mainly described, while description of common points is omitted or simplified.

FIG. 19 includes a plan view and a front view of coupled inductor 8 according to Example 10. Part (a) of FIG. 19 is a plan view, (b) is a front view, and (c) is a perspective view.

As illustrated in FIG. 19, terminals 21, 22, 31, and 32 do not protrude from lateral surfaces 11 to 14, and are disposed being embedded. Specifically, terminal 21 does not protrude from magnetic body 10 in a view in a direction orthogonal to lateral surface 11 (the positive side of the z axis, for example). Terminal 22 does not protrude from magnetic body 10 in a view in a direction orthogonal to lateral surface 12 (the positive side of the z axis, for example). Terminal 23 does not protrude from magnetic body 10 in a view in a direction orthogonal to lateral surface 13 (the positive side of the z axis, for example). Terminal 24 does not protrude from magnetic body 10 in a view in a direction orthogonal to lateral surface 14 (the positive side of the z axis, for example). More specifically, grooves are provided in lateral surfaces 11 to 14, and terminals 21, 22, 31, and 32 in correspondence thereto are provided in the grooves.

For example, terminal 21 is accommodated in one of the grooves provided in lateral surface 11. The outside surface of terminal 21 is flush with lateral surface 11. Terminal 22 is accommodated in one of the grooves provided in lateral surface 12. The outside surface of terminal 22 is flush with lateral surface 12. Terminal 31 is accommodated in one of the grooves provided in lateral surface 13. The outside surface of terminal 31 is flush with lateral surface 13. Terminal 32 is accommodated in one of the grooves provided in lateral surface 14. The outside surface of terminal 32 is flush with lateral surface 14. Note that terminals 21, 22, 31, and 32 may partially protrude from the grooves.

Magnetic body 10 may be accommodated in a resin casing. Level differences between the casing and the surface of magnetic body 10 may provide grooves for accommodating terminals 21, 22, 31, and 32.

A groove may be provided for each terminal, or a groove larger than one terminal may be provided to accommodate a plurality of terminals. For example, as shown by Examples 6 to 9, when terminals 23, 24, 33, and 34 are provided as auxiliary terminals, a groove that accommodates two terminals may be provided in each lateral surface.

According to this Example, the terminals do not protrude from the lateral surfaces of magnetic body 10, and thus the size of coupled inductor 8 can be reduced. Furthermore, mechanical shock is less likely to be directly applied to the terminals, and damage to the terminals, for instance, can be reduced. Thus, shock-resistant coupled inductor 8 can be embodied.

Note that the terminals may partially protrude from the grooves. Stated differently, a portion of each terminal may be accommodated in a groove, and another portion may protrude outward from the groove. Also in this case, the protrusion amount of a terminal can be decreased, and thus the size of coupled inductor 8 can be reduced and reliability thereof can be enhanced.

Although an example in which grooves having substantially the same sizes as those of the terminals are provided has been shown in this Example, the configuration is not limited thereto. For example, no groove may be provided in magnetic body 10. A portion of magnetic body 10 may project out to cover a terminal (so as to provide an eave).

Note that in this Example, as illustrated in (c) of FIG. 19, conductors 20 and 30 extend parallel to each other along about one and half perimeters of a quadrilateral ring at different heights inside magnetic body 10, similarly to (c) of FIG. 4. For example, a portion of conductor 20 in the quadrilateral ring shape and a portion of conductor 30 in the quadrilateral ring shape overlap in a view in the z-axis direction. Note that the shapes and layout of conductors 20 and 30 illustrated in (c) of FIG. 19 are mere examples.

### 4. Power Conversion Device

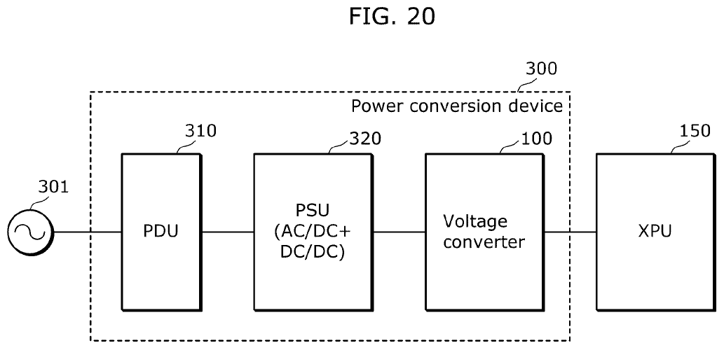

Next, a configuration of a power conversion device that includes voltage converter 100 or 200 described above is to be described with reference to FIG. 20.

FIG. 20 illustrates a configuration of power conversion device 300 according to the present embodiment. As illustrated in FIG. 20, power conversion device 300 includes power distribution unit (PDU) 310, power supply unit (PSU) 320, and voltage converter 100. Note that power conversion device 300 may include voltage converter 200 instead of voltage converter 100.

PDU 310 is a power distribution unit, and is configured to change a supply destination of alternating-current power supplied from alternating-current power supply 301. For example, PDU 310 includes a plurality of switches. In the present embodiment, PDU 310 supplies alternating-current power to PSU 320. Note that alternating-current power supply 301 is a general commercial power supply, for example.

PSU 320 is a power supply unit, converts alternating-current power supplied from PDU 310 into direct-current power, and supplies the direct-current power to voltage converter 100. PSU 320 includes an alternating current/direct current (AC/DC) converter and a DC/DC converter, for example.

Voltage converter 100 converts direct-current power supplied from PSU 320 and supplies the resultant power to XPU 150 that is a load.

As described above, power conversion device 300 includes voltage converter 100 or 200, and thus can reduce deterioration of electric properties. Specifically, the wiring length of a coupled line constituted by a plurality of inductors can be shortened, and thus not only loss can be reduced, but also operation can be stabilized by reducing ringing. Since the wiring length is shortened, parasitic inductance decreases, and thus load responsiveness is also enhanced.

### Other Embodiments

The above has described, based on the embodiments, the coupled inductor, the inductor unit, the voltage converter, and the power conversion device according to one or more aspects, yet the present disclosure is not limited to the embodiments. The present disclosure also encompasses embodiments resulting from applying, to the above embodiments, various modifications that may be conceived by those skilled in the art and embodiments resulting from combining elements in different embodiments, within a range that does not depart from the scope of the present disclosure,

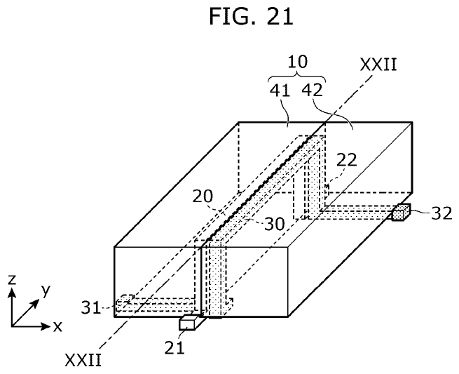

For example, magnetic body 10 may be embodied by combining a plurality of magnetic bodies. FIG. 21 is a perspective view of a coupled inductor according to a variation of the embodiment.

As illustrated in FIG. 21, magnetic body 10 includes first magnetic body 41 and second magnetic body 42. First magnetic body 41 and second magnetic body 42 constitute magnetic body 10 by being combined at the yz plane indicated by the XXII-XXII line in FIG. 21. Note that the XXII-XXII line bisects magnetic body 10 in the x-axis direction.

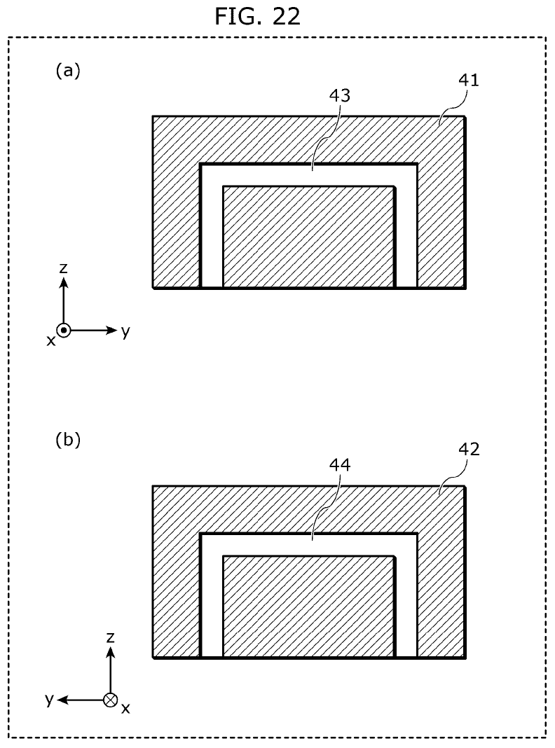

FIG. 22 shows plan views illustrating surfaces of first magnetic body 41 and second magnetic body 42 that are combined with each other. Part (a) of FIG. 22 shows first magnetic body 41, whereas (b) shows second magnetic body 42.

As illustrated in (a) of FIG. 22, groove 43 is provided in first magnetic body 41 to accommodate conductor 20 at least partially. As illustrated in (b) of FIG. 22, groove 44 is provided in second magnetic body 42 to accommodate conductor 30 at least partially.

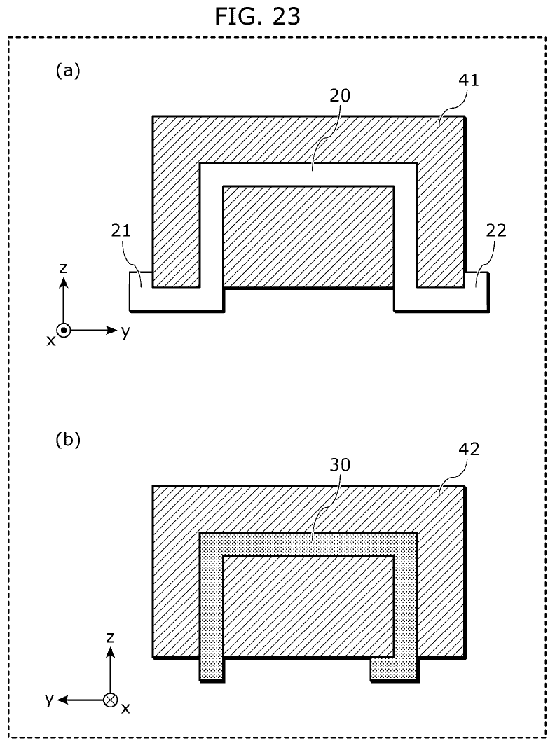

FIG. 23 shows plan views illustrating states in which conductors 20 and 30 are accommodated in first magnetic body 41 and second magnetic body 42 illustrated in FIG. 22, respectively. As illustrated in FIG. 23, in a state in which conductor 20 is at least partially accommodated in groove 43 and conductor 30 is at least partially accommodated in groove 44, the surface of first magnetic body 41 illustrated in (a) and the surface of second magnetic body 42 illustrated in (b) are combined, facing each other. At this time, first magnetic body 41 and second magnetic body 42 are mated with each other with a gap therebetween, in order to prevent the magnetic flux from being saturated. Although not illustrated, the facing surfaces of first magnetic body 41 and second magnetic body 42 are provided with a recessed-protruding structure that allows first magnetic body 41 and second magnetic body 42 to be mated with each other. Note that conductors 20 and 30 may be covered with insulating films to ensure insulating properties.

First magnetic body 41 and second magnetic body 42 are made using the same magnetic material. As an example, first magnetic body 41 and second magnetic body 42 are each made of ferrite. Core loss at a radio frequency can be reduced by using ferrite. Note that first magnetic body 41 and second magnetic body 42 may be made using different magnetic materials.

Note that in FIG. 22 and FIG. 23, grooves 43 and 44 are provided to accommodate portions of conductors 20 and 30 that extend parallel to each other in the y-axis direction. Accordingly, portions of conductors 20 and 30 that do not extend parallel to each other are exposed from the lower surface of magnetic body 10. The shapes of grooves 43 and 44 are not limited to the examples illustrated in FIG. 22.

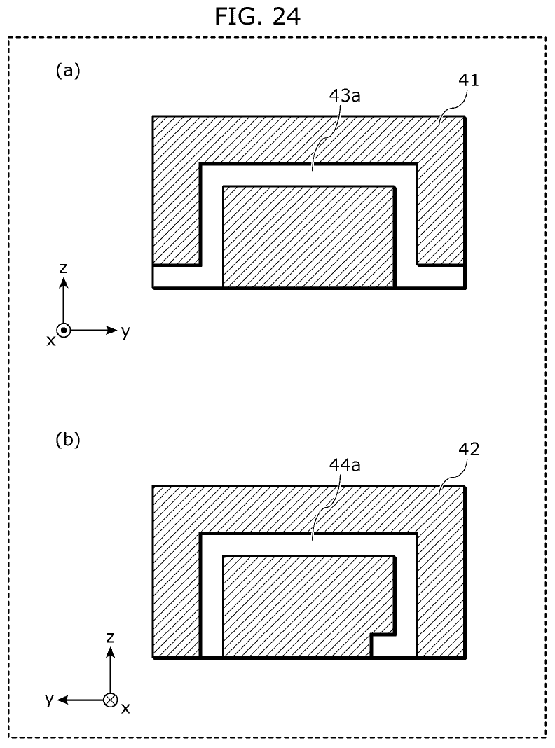

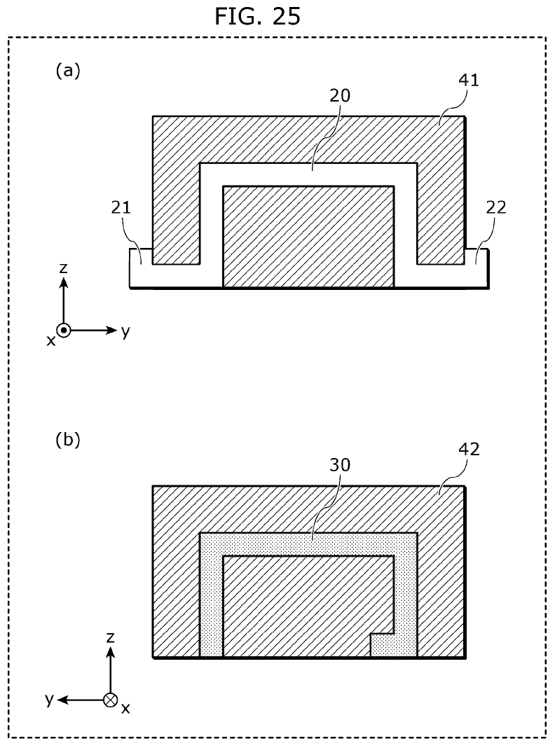

FIG. 24 shows plan views illustrating variations of surfaces of first magnetic body 41 and second magnetic body 42 that are combined with each other. Part (a) of FIG. 24 shows first magnetic body 41, whereas (b) shows second magnetic body 42. Further, FIG. 25 shows plan views illustrating states in which conductors 20 and 30 are accommodated in first magnetic body 41 and second magnetic body 42 illustrated in FIG. 24, respectively.

As illustrated in FIG. 24, grooves 43a and 44a having shapes that can accommodate potions of conductors 20 and 30 that do not extend parallel to each other may be provided. In this case, as illustrated in FIG. 25, conductors 20 and 30 (except terminals that are not illustrated) can be almost entirely accommodated in first magnetic body 41 and second magnetic body 42, respectively. Accordingly, the lower surface of magnetic body 10 is flat, which can contribute to readiness of mounting magnetic body 10 and size reduction.

Note that magnetic body 10 may be embodied by combining three or more magnetic bodies. Although FIG. 21 illustrates an example in which magnetic body 10 is bisected, the sizes and shapes of plural magnetic bodies may be different from one another.

For example, in the embodiment above, the power feeding method of the voltage converter may be a horizontal power feeding method. For example, in inductor unit 120 that includes plural coupled inductors 1 according to Example 1 illustrated in FIG. 5, the FET circuits and input capacitor Cin may be mounted on the negative side of the y axis. In each of plural coupled inductors 1, since terminal 21 is disposed on the negative side of the y axis, the wiring length can be shortened.

For example, the above embodiment has shown an example in which lateral surfaces 11 and 12 are smaller than lateral surfaces 13 and 14, but the sizes are not limited thereto. Lateral surfaces 11 and 12 may have the same size as that of lateral surfaces 13 and 14 or may be larger than lateral surfaces 13 and 14. The positional relation between lateral surface 11 and lateral surface 12 may be inverted. Stated differently, lateral surface 11 may be located on the positive side of the y axis, and lateral surface 12 may be located on the negative side of the y axis. The positional relation between lateral surface 13 and lateral surface 14 may be inverted. Stated differently, lateral surface 13 may be located on the positive side of the x axis, and lateral surface 14 may be located on the negative side of the x axis.

For example, the above embodiment has shown an example in which upper surface 15 and lower surface 16 are larger than lateral surfaces 11 to 14, but the sizes are not limited thereto. Upper surface 15 and lower surface 16 may have the same size as those of lateral surfaces 11 to 14 or may be smaller than lateral surfaces 11 to 14.

5 Various changes, replacement, addition, or omission, for instance, can be made to the above embodiments within the scope of the claims and the equivalents thereof.

### INDUSTRIAL APPLICABILITY

The present disclosure is applicable as a coupled inductor, for instance, that can reduce deterioration of electrical properties when multiple phases are provided, and is applicable to an inductor unit, a voltage converter, a power supply circuit, and a power conversion device, for example.

1. A coupled inductor comprising:
a magnetic body;
a first conductor provided at least partially inside the magnetic body; and
a second conductor provided at least partially inside the magnetic body, the second conductor being coupled to the first conductor,
wherein the magnetic body includes:
a first surface and a second surface facing away from each other; and
a third surface and a fourth surface facing away from each other and orthogonal to the first surface and the second surface,
the first conductor includes:
a first terminal provided at the first surface; and
a second terminal provided at the second surface, and
the second conductor includes:
a third terminal provided at the third surface; and
a fourth terminal provided at the fourth surface.

2. The coupled inductor according to claim 1,
wherein the first terminal is provided in a position in the first surface closer to the third surface than to the fourth surface,
the second terminal is provided in a position in the second surface closer to the fourth surface than to the third surface,
the third terminal is provided in a position in the third surface closer to the first surface than to the second surface, and
the fourth terminal is provided in a position in the fourth surface closer to the second surface than to the first surface.

3. A coupled inductor comprising:
a magnetic body;
a first conductor provided at least partially inside the magnetic body; and
a second conductor provided at least partially inside the magnetic body, the second conductor being coupled to the first conductor,
wherein the magnetic body includes:
a first surface and a second surface facing away from each other; and
a third surface and a fourth surface facing away from each other and orthogonal to the first surface and the second surface,
the first conductor includes:
a first terminal and a second terminal provided at the fourth surface, and
the second conductor includes:
a third terminal provided at the second surface; and
a fourth terminal provided at the first surface.

4. The coupled inductor according to claim 3,
wherein the fourth surface is closer to a load than the third surface is, the load being configured to receive supply of a current flowing through the first conductor.

5. A coupled inductor comprising:
a magnetic body;
a first conductor provided at least partially inside the magnetic body; and
a second conductor provided at least partially inside the magnetic body, the second conductor being coupled to the first conductor,
wherein the magnetic body includes:
a third surface and a fourth surface facing away from each other; and
a fifth surface and a sixth surface facing away from each other and orthogonal to the third surface and the fourth surface,
the fifth surface faces a substrate on which the coupled inductor is to be mounted,
the first conductor includes:
a first terminal provided at the sixth surface; and
a second terminal provided at the fifth surface, and
the second conductor includes:
a third terminal provided at the third surface; and
a fourth terminal provided at the fourth surface.

6. The coupled inductor according to claim 5,
wherein the third terminal is provided continuously at the third surface and the sixth surface, and
the fourth terminal is provided continuously at the fourth surface and the fifth surface.

7. The coupled inductor according to claim 1,
wherein the first conductor further includes:
a fifth terminal provided at a surface of the magnetic body that is same as a surface at which the third terminal is provided; and
a sixth terminal provided at a surface of the magnetic body that is same as a surface at which the fourth terminal is provided, and
the second conductor further includes:
a seventh terminal provided at a surface of the magnetic body that is same as a surface at which the first terminal is provided; and
an eighth terminal provided at a surface of the magnetic body that is same as a surface at which the second terminal is provided.

8. The coupled inductor according to claim 1,
wherein the first terminal does not protrude from the magnetic body in a view in a direction orthogonal to a surface at which the first terminal is provided,
the second terminal does not protrude from the magnetic body in a view in a direction orthogonal to a surface at which the second terminal is provided,
the third terminal does not protrude from the magnetic body in a view in a direction orthogonal to a surface at which the third terminal is provided, and
the fourth terminal does not protrude from the magnetic body in a view in a direction orthogonal to a surface at which the fourth terminal is provided.

9. An inductor unit comprising:
a first coupled inductor that is the coupled inductor according to claim 1; and
a second coupled inductor facing the fourth surface of the first coupled inductor,
wherein the second coupled inductor has a mirror-inverted structure of a structure of the first coupled inductor.

10. A voltage converter comprising:
the coupled inductor according to claim 5;
a switching element;
an input capacitor element; and
an output capacitor element,
wherein at least one of the input capacitor element or the switching element faces the sixth surface, and
the output capacitor element faces the fifth surface.

11. A voltage converter comprising:
the coupled inductor according to claim 1.

12. A power conversion device comprising:
the voltage converter according to claim 10.
